(19) United States
(12) Patent Application Publication
(10) Pub. No.: US 2025/0291141 A1
(43) Pub. Date: Sep. 18, 2025

(54) OPTICAL MODULE

(71) Applicant: HISENSE BROADBAND MULTIMEDIA TECHNOLOGIES CO., LTD., Qingdao (CN)

(72) Inventor: Hongchao PAN, Qingdao (CN)

(21) Appl. No.: 19/224,480

(22) Filed: May 30, 2025

Related U.S. Application Data
(63) Continuation of application No. PCT/CN2023/085187, filed on Mar. 30, 2023.

(30) Foreign Application Priority Data
Nov. 30, 2022 (CN) 202211525316.3
Nov. 30, 2022 (CN) 202223203816.3
Dec. 16, 2022 (CN) 202211623882.8

(51) Int. Cl. G02B 6/42

(52) U.S. Cl. CPC G02B 6/4278; G02B 6/4231; G02B 6/428

(57) ABSTRACT

An optical module comprising: a shell having an unlocker movement guiding structure, a positioning protrusion and a first pivotable positioning member; and an unlocking mechanism connected to the shell and comprises a handle and an unlocker, the handle has a second pivotable positioning member and an unlocking surface, a return spring is arranged in an accommodation cavity of the unlocker movement guiding structure, one end of the unlocker is inserted into the accommodation cavity, and an opposite end contacts the unlocking surface, such that a force applied when the handle is rotated drives the unlocker to slide on the shell, which drives the unlocker to compress the return spring until locking on the positioning protrusion is unlocked, and as the applied force is removed, the return spring drives the unlocker to slide, which then drives the handle to rotate back.

### CROSS-REFERENCE TO RELATED APPLICATIONS

This application is a continuation of PCT/CN2023/085187 filed on Mar. 30, 2023, which claims priority to application Ser. No. 202211623882.8 filed on Dec. 16, 2022, No. 202223203816.3 filed on Nov. 30, 2022, and No. 202211525316.3 filed on Nov. 30, 2022, with the China National Intellectual Property Administration (CNIPA), the entire disclosures of which are incorporated herein by reference.

### FIELD OF THE INVENTION

The present disclosure relates to the field of fiber-optic communication technology, and generally to an optical module.

### BACKGROUND OF THE INVENTION

With the development of emerging services and application models such as cloud computing, mobile Internet, and video streaming, the advancements of optical communication technology have become increasingly important. In the optical communication technology, an optical module is the tool to realize the mutual conversion of photoelectric signals, and is one of the key components in optical communication equipment. To meet the demands of the development of optical communication technology, the transmission rate of the optical module continues to increase.

An electrical module is composed of optoelectronic devices, functional circuits and optical interfaces, and serves as an essential part of fiber-optic communication systems.

### SUMMARY OF THE INVENTION

The present disclosure provides an optical module, which comprises:
a shell having an unlocker movement guiding structure that is configured to limit movement position of an unlocker, a positioning protrusion arranged on an outer wall of the shell, and a first pivotable positioning member arranged on a side of the shell, wherein the positioning protrusion and the unlocker movement guiding structure are arranged on a same side of the shell; and
an unlocking mechanism that is connected onto a handle and comprises—the handle and the unlocker, the handle being disposed thereon with a second pivotable positioning member and an unlocking surface, wherein
the handle is pivotally connected to the shell through engagement and connection between the second pivotable positioning member and the first pivotable positioning member;
a return spring is arranged in an accommodation cavity of the unlocker movement guiding structure, and the return spring connects the unlocker and the shell;
one side of the unlocker is inserted into the accommodation cavity of the unlocker movement guiding structure, and an end of another side of the unlocker opposite to the one side contacts the unlocking surface, such that a force applied when the handle is rotated drives the unlocker to slide on the shell, wherein, the applied force drives the unlocker to slide and compress the return spring until locking on the positioning protrusion by an external device is unlocked during an unlocking process; and after the unlocking process, as the applied force is removed, the compressed return spring drives the unlocker to slide on the shell, and sliding of the unlocker drives the handle to rotate back to its original position.

### BRIEF DESCRIPTION OF THE DRAWINGS

The accompanying drawings to be used in some embodiments of the present disclosure—are described briefly below so as to more clearly describe the technical solutions of the present disclosure. Apparently, the accompanying drawings described below are only those of some embodiments of the present disclosure, and for those skilled in the art, other drawings may also be derived from these accompanying drawings. In addition, the accompanying drawings as described below may be regarded as schematic diagrams and are not intended to limit the actual size of the product, the actual process of the method, or the actual timing of the signal involved in the disclosed embodiments.

FIG. 1 is a connection relationship diagram of an optical communication system according to some embodiments of the present disclosure;

FIG. 2 is a structural diagram of a host computer according to some embodiments of the present disclosure;

FIG. 3 is a first structural schematic diagram from another perspective of an optical module according to some embodiments of the present disclosure;

FIG. 4 is a second structural schematic diagram of an optical module according to some embodiments of the present disclosure;

FIG. 5 is an exploded structural schematic diagram of an optical module according to some embodiments of the present disclosure;

FIG. 6 is a first structural schematic diagram from another perspective of the lower shell part in an optical module according to some embodiments of the present disclosure;

FIG. 7 is a second structural schematic diagram from another perspective of the lower shell part in an optical module according to some embodiments of the present disclosure;

FIG. 8 is a partial sectional view of the lower shell part in an optical module according to some embodiments of the present disclosure;

FIG. 9 is a third structural schematic diagram from another perspective of the lower shell part in an optical module according to some embodiments of the present disclosure;

FIG. 10 is a first structural schematic diagram of an unlocker in an optical module according to some embodiments of the present disclosure;

FIG. 11 is a second structural schematic diagram of an unlocker in an optical module according to some embodiments of the present disclosure;

FIG. 12 is a third structural schematic diagram of an unlocker in an optical module according to some embodiments of the present disclosure;

FIG. 13 is a partial assembly schematic diagram of a lower shell part and an unlocker in an optical module according to some embodiments of the present disclosure;

FIG. 14 is a first structural schematic diagram of a handle in an optical module according to some embodiments of the present disclosure;

FIG. 15 is a second structural schematic diagram of a handle in an optical module according to some embodiments of the present disclosure;

FIG. 16 is a partial assembly schematic diagram of a lower shell part, a handle and an unlocker in an optical module according to some embodiments of the present disclosure;

FIG. 17 is a schematic diagram of a locked state of an optical module according to some embodiments of the present disclosure;

FIG. 18 is a sectional view of a locked state of an optical module according to some embodiments of the present disclosure;

FIG. 19 is a schematic diagram of an unlocked state of an optical module according to some embodiments of the present disclosure;

FIG. 20 is a sectional view of an unlocked state of an optical module according to some embodiments of the present disclosure;

FIG. 21 is a structural schematic diagram of an electrical module according to some embodiments of the present disclosure;

FIG. 22 is an exploded structural schematic diagram of an electrical module according to some embodiments of the present disclosure;

FIG. 23 is a first structural schematic diagram of a cover plate in an electrical module according to some embodiments of the present disclosure;

FIG. 24 is a second structural schematic diagram of a cover plate in an electrical module according to some embodiments of the present disclosure;

FIG. 25 is a third structural schematic diagram of a cover plate in an electrical module according to some embodiments of the present disclosure;

FIG. 26 is a first structural schematic diagram of an unlocker in an electrical module according to some embodiments of the present disclosure;

FIG. 27 is a second structural schematic diagram of an unlocker in an electrical module according to some embodiments of the present disclosure;

FIG. 28 is a third structural schematic diagram of an unlocker in an electrical module according to some embodiments of the present disclosure;

FIG. 29 is a first assembly schematic diagram of a cover plate and an unlocker in an electrical module according to some embodiments of the present disclosure;

FIG. 30 is a second assembly schematic diagram of a cover plate and an unlocker in an electrical module according to some embodiments of the present disclosure;

FIG. 31 is an assembly sectional view of a cover plate and an unlocker in an electrical module according to some embodiments of the present disclosure;

FIG. 32 is a structural schematic diagram of a lower shell part in an electrical module according to some embodiments of the present disclosure;

FIG. 33 is a first partial structural schematic diagram of a lower shell part in an electrical module according to some embodiments of the present disclosure;

FIG. 34 is a second partial structural schematic diagram of a lower shell part in an electrical module according to some embodiments of the present disclosure;

FIG. 35 is an assembly schematic diagram of a circuit board and an electrical connector in an electrical module according to some embodiments of the present disclosure;

FIG. 36 is an assembly schematic diagram of a lower shell part, a circuit board and an electrical connector in an electrical module according to some embodiments of the present disclosure;

FIG. 37 is a first structural schematic diagram of a handle in an electrical module according to some embodiments of the present disclosure;

FIG. 38 is a second structural schematic diagram of a handle in an electrical module according to some embodiments of the present disclosure;

FIG. 39 is a first partial assembly schematic diagram of a handle and a lower shell part in an electrical module according to some embodiments of the present disclosure;

FIG. 40 is a second partial assembly schematic diagram of a handle and a lower shell part in an electrical module according to some embodiments of the present disclosure;

FIG. 41 is a partial assembly schematic diagram of a handle, a lower shell part, a cover plate and an unlocker in an electrical module according to some embodiments of the present disclosure;

FIG. 42 is a partial assembly sectional view of a handle, a lower shell part, a cover plate and an unlocker in an electrical module according to some embodiments of the present disclosure;

FIG. 43 is a schematic diagram of an unlocked state of an electrical module according to some embodiments of the present disclosure; and

FIG. 44 is a sectional view of an unlocked state of an electrical module according to some embodiments of the present disclosure.

### DETAILED DESCRIPTION OF THE EMBODIMENTS

The following describe the technical solutions in some embodiments of the present disclosure clearly and in detail in combination with the accompanying drawings. Although the embodiments are described in detail, the present invention is not limited to any specific details. Obviously, the described embodiments are only a part of the embodiments of the present disclosure, rather than all embodiments. The present disclosure may be embodied in many different forms and should not be construed as being limited to any specific description. Rather, the present invention should be construed to cover not only the embodiments disclosed, but also various alternatives, modifications, equivalents and other embodiments that fall within the spirit and scope of the present disclosure.

Unless the context otherwise requires, throughout the specification and claims, the singular forms should be construed to include the plural forms as well. It should also be understood that the terms used in the present disclosure such as “comprise” and its other forms, such as the third person singular form “comprises” and the present participle form “comprising”, are open-ended and specify the presence of the stated features but not preclude the presence or addition of one or more other features. In the description, terms such as “one embodiment”, “some embodiments”, “exemplary embodiments”, “example”, “specific example”, or “some examples” are intended to indicate that specific features, structures, materials, or characteristics related to the embodiment or example are included in at least one embodiment or example of the present disclosure. The schematic representations of the above terms do not necessarily refer to the same embodiment(s) or example(s). Furthermore, the specific features, structures, materials, or characteristics may be included in any one or more embodiments or examples in any appropriate manner.

In this document, terms such as “first”, “second” and the like are used only to distinguish features with the same or similar names, which should not be limited by such terms. For example, these terms should not be construed as indicating or implying relative importance or implicitly specifying the number of the technical features indicated. Thus, features defined with “first”, “second” and the like may explicitly or implicitly comprise one or more of such features. Additionally, a first feature in one example may be referred to as a second feature in another example without departing from the teachings of the present disclosure. In the description of the embodiments of the present disclosure, unless otherwise specified, the term “a plurality” means two or more.

In the description of some embodiments, the terms “coupled” and “connected” and their extensions may be used. For example, the term “connected” as used in describing some embodiments may indicate that two or more components are in direct or indirect physical or electrical contact with each other. For another example, the term “coupled” as used in describing some embodiments may indicate that two or more components are in direct or indirect physical or electrical contact. However, the term “coupled” or “communicatively coupled” may also refer to two or more components that are not in direct contact with each other, but still cooperate or interact with each other. The embodiments disclosed herein are not necessarily limited to the contents herein.

The phrase “at least one of A, B and C” has the same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The use of “adapted to” or “configured to” herein means an open and inclusive language, which does not exclude devices that are adapted to or configured to perform additional tasks or steps.

The term “about”, “substantially” or “approximately” as used herein includes a stated value and an average value within an acceptable range of deviation of the value determined by a person of ordinary skill in the art, considering measurement in question and errors associated with measurement of a particular quantity (i.e., limitations of a measurement system).

Optical communication technology establishes information transmission between information processing devices. This technology loads information onto light and utilizes the propagation of light to realize the transmission of information, and the light loaded with information is the optical signal. The propagation of an optical signal within information transmission devices can reduce optical power loss, enabling high-speed, long-distance, and low-cost information transmission. The information that can be processed by the information processing device exists in the form of an electrical signal. Optical network terminals/gateways, routers, switches, mobile phones, computers, servers, tablets, and televisions are common information processing devices, while optical fibers and optical waveguides are common information transmission devices.

The mutual conversion between the optical signal and the electrical signal between the information processing device and the information transmission device is realized through optical modules. For example, an optical fiber may be connected to the optical signal input end and/or optical signal output end of an optical module, while an optical network terminal may be connected to the electrical signal input end and/or electrical signal output end of an optical module, wherein, a first optical signal from the optical fiber can be transmitted into the optical module, where the optical module converts the first optical signal into a first electrical signal and transmits the first electrical signal into the optical network terminal; and wherein, a second electrical signal from the optical network terminal can be transmitted into the optical module, where the optical module converts the second electrical signal into a second optical signal and transmits the second optical signal into the optical fiber. Since information processing devices can be interconnected via the electrical signal networks, only one type of information processing device needs to be directly connected to the optical module, without requiring all types of information processing devices to be directly connected to the optical module, wherein, the information processing device directly connected to the optical module, such as the optical network terminal, is referred to as a host computer of the optical module.

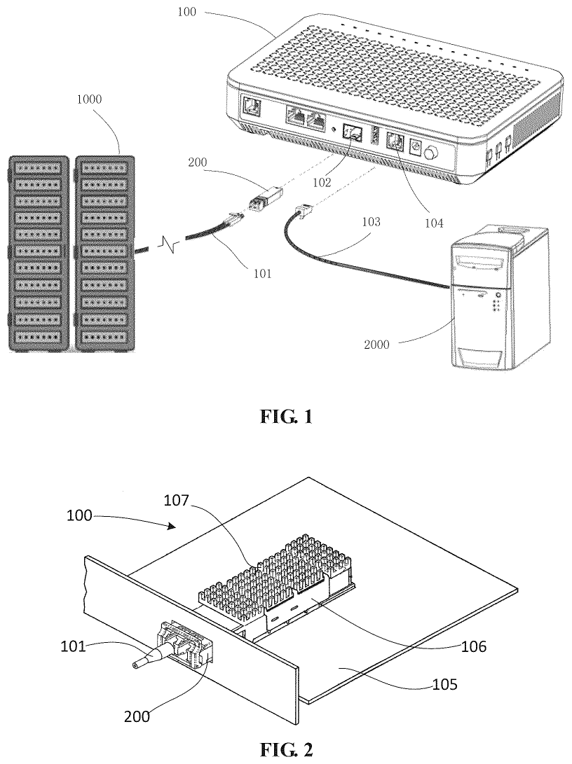

FIG. 1 is a partial architecture diagram of an optical communication system according to some embodiments. As shown in FIG. 1, the partial optical communication system comprises a remote information processing device 1000, a local information processing device 2000, a host computer 100, an optical module 200, an optical fiber 101 and a network cable 103.

One end of the optical fiber 101 may extend toward and be connected to the remote information processing device 1000 (e.g., a remote server), and the other end thereof may be connected to the optical module 200 via an optical interface connecting the optical module 200. The optical fiber itself may support long-distance signal transmission, such as that of over multi-kilometer distances (6-8 km). Based on this, if a repeater is used, infinite-distance transmission may be achieved theoretically. Therefore, in a typical optical communication system, a distance between the remote information processing device 1000 and the host computer 100 may usually reach several kilometers, tens of kilometers or hundreds of kilometers. The optical signal can undergo total internal reflection within the optical fiber 101, allowing its propagation in the direction of the total internal reflection while maintaining nearly the original optical power, wherein the optical signal may undergo multiple total internal reflections within the optical fiber 101, thereby transmitting the optical signal from the remote information processing device 1000 to the optical module 200, or propagating the light from the optical module 200 toward the remote information processing device 1000. This enables long-distance, low-power-loss information transmission.

The optical fiber 101 may be provided as a single fiber or multiple fibers (two or more). The connection between the optical fiber 101 and the optical module 200 may be either a pluggable removable connection or a fixed connection.

The host computer 100 may include an optical module interface 102 configured to connect the optical module 200, thereby establishing a unidirectional/bidirectional electrical signal connection between the host computer 100 and the optical module 200. The host computer 100 may be configured to provide a data signal to the optical module 200, or receive a data signal from the optical module 200, or monitor and control the operational state of the optical module 200.

The host computer 100 may include an external electrical interface, such as a Universal Serial Bus (USB) interface and a network cable interface 104. Such external electrical interfaces can be connected to an electrical signal network. For example, the network cable interface 104 is configured to connect the network cable 103, thereby establishing a unidirectional/bidirectional electrical signal connection between the host computer 100 and the network cable 103.

Optical Network Units (ONUs), Optical Line Terminals (OLTs), and Optical Network Terminals (ONTs) and a data center server are common host computers.

One end of the network cable 103 is connected to the local information processing device 2000 and the other end is connected to the host computer 100, and the network cable 103 establishes an electrical signal connection between the local information processing device 2000 and the host computer 100.

For example, the third electrical signal originating from the local information processing device 2000 is transmitted to the host computer 100 via the network cable 103. The host computer 100 generates a second electrical signal based on the third electrical signal. The second electrical signal from the host computer 100 is then transmitted to the optical module 200, where it is converted into a second optical signal by the optical module 200. This second optical signal is subsequently transmitted to the optical fiber 101 by the optical module 200 for propagation toward the remote information processing device 1000 in the optical fiber 101.

For example, the first optical signal from the direction of the remote information processing device 1000 propagates through the optical fiber 101. The first optical signal from the optical fiber 101 is then transmitted to the optical module 200, where it is converted into a first electrical signal by the optical module 200. This first electrical signal is subsequently transmitted to the host computer 100 by the optical module 200, and the host computer 100 generates a fourth electrical signal based on the first electrical signal and finally transmits the fourth electrical signal to the local information processing device 2000.

The optical module is a tool to realize the mutual conversion of the optical signal and the electrical signal. During the above-mentioned conversion processes between the optical signal and the electrical signal, the information content remains unchanged, while the encoding/decoding schemes of the information may be modified.

The electrical module is a low-power consumption module with interface capabilities, located in the network cable interface 104 of the host computer 100. The network cable 103 is inserted into the electrical module to realize the electrical connection between the local information processing device 2000 and the host computer 100 through the combined pathway of the network cable 103 and the electrical module.

FIG. 2 is a partial structural diagram of a host computer according to some embodiments. To clearly illustrate the connection relationship between the optical module 200 and the host computer 100, FIG. 2 only shows the structure of the host computer 100 related to the optical module 200. As shown in FIG. 2, the host computer 100 further comprises a PCB (printed circuit board) 105 disposed within the shell, a cage 106 surface-mounted on the PCB 105, a heat sink 107 installed on the cage 106, and an electrical connector (not shown) housed inside the cage 106. The heat sink 107 features protrusions to increase heat dissipation area, and the fin-shaped structure are a common type of such protrusions.

The optical module 200 is inserted into the cage 106 of the host computer 100, where the cage 106 secures the optical module 200 in position. The heat generated by the optical module 200 is conducted to the cage 106 and then dissipated through the heat sink 107. After the optical module 200 is inserted into the cage 106, an electrical interface of the optical module 200 is connected to the electrical connector in the cage 106.

The optical module and the electrical module may be collectively referred to as a pluggable electronic module. In the process of use, frequent repetitive insertion and extraction—such as in switch applications—necessitates that the pluggable electronic module structure reliably locks and unlocks, so that the pluggable electronic module can be smoothly disengaged from the cage on the switch, consequently requiring the pluggable electronic module to incorporate a self-contained unlocking mechanism.

Push-pull latching is a common unlocking mechanism for the optical module. The optical module employing an SC fiber interface and some utilizing LC fiber interfaces must implement this push-pull latching mechanism.

However, the commonly used materials of the handles in the push-pull latching mechanism are steel wire and stamped stainless steel. When a stamped stainless steel handle is subjected to improper operation or deformation in either the optical module's mating cage or the board, unlocking problems frequently occur, which is manifested as the deformation of the handle crossbeam under force and the reduction of the unlocking travel, resulting in the unlocking difficulties.

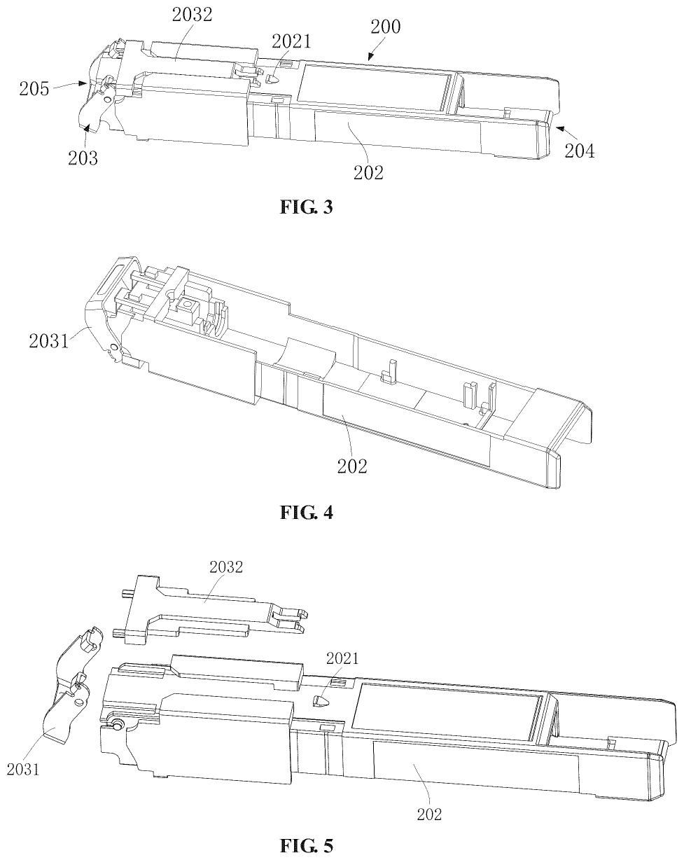

FIG. 3 is a first structural schematic diagram of an optical module according to some embodiments of the present disclosure, FIG. 4 is a second structural schematic diagram of an optical module according to some embodiments of the present disclosure, and FIG. 5 is an exploded structural schematic diagram of an optical module according to some embodiments of the present disclosure. As shown in FIG. 3, FIG. 4, and FIG. 5, the optical module 200 comprises a shell, and a circuit board and an optical assembly arranged in the shell.

The shell comprises an upper shell part and a lower shell part 202, and the upper shell part is covered on the lower shell part 202 to form the shell with the opening 204 and the opening 205, wherein the outer contour of the shell is generally rectangular cuboid-shaped.

In some embodiments of the present disclosure, the left-right direction (also referred to as the first direction) corresponds to the plug-in direction of the optical module 200, where the pluggable end for inserting into the host computer 100 is located at the right end. The front-rear direction (also referred to as the second direction) refers to the direction perpendicular to the left-right direction in the horizontal plane, wherein, when the optical module 200 is oriented with its upper shell facing upward and its pluggable end at the right, the visible face in this view is defined as the front side, and the rear side is the opposite surface.

In some embodiments of the present disclosure, the lower shell part 202 comprises a bottom plate and two lower side plates perpendicularly disposed on opposite sides of the bottom plate, while the upper shell part comprises a cover plate that is covered on the two lower side plates of the lower shell part 202 to form the shell.

In some embodiments, the lower shell part 202 comprises a bottom plate and two lower side plates perpendicularly disposed on opposite sides of the bottom plate, while the upper shell part comprises a cover plate and two upper side plates perpendicularly disposed on opposite sides of the cover plate. The two upper side plates are combined with the two lower side plates, such that the upper shell part is covered on the lower shell part 202.

A direction of a connection line between the opening 204 and the opening 205 may either align with or deviate from the length direction of the optical module 200. For example, the opening 204 is located at the end of the optical module 200 (right end of FIG. 3), and the opening 205 is also located at the end of the optical module 200 (left end of FIG. 3). Alternatively, the opening 204 is located at the end of the optical module 200, and the opening 205 is located at the side of the optical module 200. The opening 204 is an electrical port, from which the circuit board's gold fingers protrude therefrom to be inserted into the host computer 100 (e.g., an optical network terminal), while the opening 205 is an optical port, which is configured to connect an external optical fiber 101, thereby connecting the external optical fiber 101 to the internal optical assembly of the optical module 200.

The assembly mode of combining the upper shell part and the lower shell part 202 facilitates the installation of components, such as the circuit board and optical assembly, into the shell, with the upper shell part and the lower shell part 202 forming encapsulated protection for these components. In addition, when assembling components such as the circuit board and optical assembly, this assembly mode enables the deployment of positioning elements, thermal management components, and electromagnetic shielding parts for these components, which facilitates automated production.

In some embodiments, the upper shell part and the lower shell part 202 are generally made of metal materials, which are conducive to electromagnetic shielding and heat dissipation.

In some embodiments, the optical module 200 further comprises an unlocking mechanism 203 located outside of the shell thereof. The unlocking mechanism 203 is configured to realize a fixed connection between the optical module 200 and the host computer 100, or to release the fixed connection between the optical module 200 and the host computer 100.

For example, the unlocking mechanism 203 is located on the outer wall of the lower shell part 202 and has an engagement component that is matched with the cage 106 of the host computer 100 (e.g., the cage of an optical network terminal). When the optical module 200 is inserted into the cage 106 of the host computer 100, the engagement component of the unlocking mechanism 203 secures the optical module 200 within the cage 106 of the host computer 100. When the unlocking mechanism 203 is pulled, the engagement component of the unlocking mechanism 203 moves accordingly, changing the connection relationship between the engagement component and the host computer 100 to release the engagement between the optical module 200 and the host computer 100, so that the optical module 200 may be drawn out of the cage 106 of the host computer 100.

The circuit board comprises circuit wires, electronic elements, chips and the like. The electronic elements and the chips are connected together through the circuit wires according to a circuit design, so as to achieve functions such as power supply, electrical signal transmission and grounding. The electronic elements may include, for example, capacitors, resistors, triodes, and metal-oxide-semiconductor field-effect transistors (MOSFETs). The chips may include, for example, a microcontroller unit (MCU), a laser driver chip, a limiting amplifier (LA), a clock and data recovery (CDR) chip, a power management chip and a digital signal processing (DSP) chip.

The circuit board is typically a rigid circuit board. Due to its relatively hard material properties, the rigid circuit board may additionally serve a load-bearing function. For example, the rigid circuit board may stably bear the above-mentioned electronic components and chips. The rigid circuit board may also stably carry the optical assembly when it is located on the circuit board. Furthermore, the rigid circuit board may also be inserted into the electrical connectors in the cage 106 of the host computer 100.

The circuit board also comprises a gold finger formed on a surface of an end thereof, which is composed of a plurality of pins independent from each other. When the circuit board is inserted into the cage 106, the gold finger establishes electrical connection with the electrical connector in the cage 106. The gold finger may be disposed only on a surface of one side of the circuit board, or on surfaces of both upper and lower sides of the circuit board to adapt to occasions where a large number of pins are required. The gold finger is configured to establish electrical connection with the host computer 100 to enable power supply, grounding, I2C signal transmission, data signal transmission, etc.

Certainly, flexible circuit boards are also used in some optical modules. The flexible circuit board is generally used in conjunction with the rigid circuit board as a supplement to the rigid circuit board. For example, a flexible circuit board may be used to connect a rigid circuit board and an optical assembly.

In some embodiments, the unlocking mechanism 203 generally comprises a handle 2031 and an unlocker 2032, and the handle 2031 on the optical module is commonly made of steel wire and stamped stainless steel. The dimensional accuracy of the steel wire handles is inferior to that of stamped stainless steel handles. Additionally, to ensure sufficient handle strength, steel wire with a diameter exceeding 0.7 mm is required to be used, which is easy to cause the top or bottom surface dimensions to exceed the agreement specifications, leading to poor compatibility. In contrast, stamped stainless steel handles offer higher machining precision, allow for more complex shape designs, and exhibit better compatibility.

The stamped stainless steel handle generally comprises structural elements including a crossbeam, an unlocking surface, positioning holes and anti-detachment hooks, wherein the positioning holes provide alignment for the handle to secure the handle to the base of the lower shell part 202; the unlocking surface is in contact with the unlocker 2032 and pushes the unlocker 2032 to achieve unlocking; the crossbeam connects the unlocking surface and the main structure of the handle; and anti-detachment hooks link the crossbeam to the unlocking assembly to prevent abnormal detachment of the handle from the base.

However, during the use of the stamped stainless steel handle, due to improper operation or deformation in the optical module's mating cage or the board, it is easy to have unlocking problems, which is manifested as the deformation of the handle crossbeam under force, which hinders the movement of the unlocker and causes unlocking difficulties.

The cause of the deformation is the insufficient width and structural strength of the crossbeam. When the unlocker is hindered by an external force, a force to the left is generated to act on the unlocking surface of the handle. The crossbeam section in the middle is deformed by the force because the unlocking surface is far away from the positioning holes of the handle. However, the optical module's dimensions must strictly comply with MSA (Multi-Source Agreement) standards (for optical modules, the MSA standards not only define the external size, but also define its electrical port and optical port, so the optical module supplier must strictly abide by the MSA standards when designing the system to ensure the operability and interchangeability among optical modules), and the deformation problem cannot be solved by widening the crossbeam alone.

In order to solve the above-mentioned problem, the present disclosure provides an optical module. The optical module arranges the unlocking surface of the handle and the positioning hole on the same vertical surface (e.g., a same cantilever). The crossbeam structure is only used for connecting the vertical surface and anti-detachment hooks, and does not transmit the force between the handle and the unlocker, so that the motion formation of the unlocker can be better guaranteed, and the unlocking function is guaranteed to be reliable.

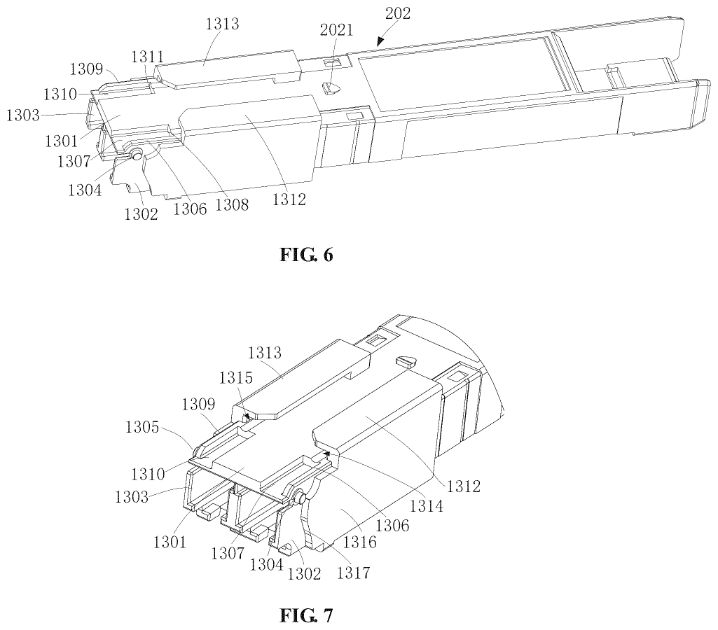

FIG. 6 is a first structural schematic diagram from another perspective of the bottom shell of an optical module according to some embodiments of the present disclosure, and FIG. 7 is a second structural schematic diagram from another perspective of the bottom shell of an optical module according to some embodiments of the present disclosure. As shown in FIG. 6 and FIG. 7, the optical module provided in this disclosure comprises a lower shell part 202 and an unlocking mechanism 203. The unlocking mechanism 203 comprises a handle 2031 and an unlocker 2032. One end of the handle 2031 is rotated and connected to the lower shell part 202, the unlocker 2032 is connected with the outer wall of the lower shell part 202, and the unlocking surface of the handle 2031 is in contact with the unlocker 2032. When the handle 2031 rotates, the unlocking surface makes the unlocker 2032 to move rightward on the lower shell part 202 so as to unlock the optical module 200.

In order to connect the unlocking mechanism 203, one end of the lower shell part 202 comprises a base. The base comprises a bottom plate 1301, a first side plate 1302 and a second side plate 1303, wherein in the width direction (i.e., the front-rear direction or the second direction) of the optical module 200, the first side plate 1302 and the second side plate 1303 are arranged opposite to each other and are respectively connected to both ends of the bottom plate 1301. Thus, the base is a U-shaped seat formed by the bottom plate 1301, the first side plate 1302 and the second side plate 1303.

The first side plate 1302 is provided with a first positioning column 1304, and the first positioning column 1304 extends outward from the first side plate 1302 to the outside of the lower shell part 202. The second side plate 1303 is provided with a second positioning column 1305, and the second positioning column 1305 extends outward from the second side plate 1303 to the exterior of the lower shell part 202. The first positioning column 1304 is arranged opposite to the second positioning column 1305. The handle 2031 is connected with the lower shell part 202 through the first positioning column 1304 and the second positioning column 1305, and the handle 2031 can rotate around the first positioning column 1304 and the second positioning column 1305. In some embodiments, the first side plate 1302 is provided with a first boss 1316, and the first boss 1316 extends outward from the first side plate 1302 to the outside of the lower shell part 202. In the length direction of the optical module 200 (i.e., the left-right direction or the first direction), the length of the first boss 1316 is smaller than the length of the first side plate 1302, so that the left side surface of the first boss 1316 is recessed relative to the left side surface of the first side plate 1302 in the length direction of the optical module 200.

The second side plate 1303 is provided with a second boss, and the second boss extends outward from the second side plate 1303 to the outside of the lower shell part 202. In the length direction of the optical module 200, the length of the second boss is smaller than the length of the second side plate 1303, so that the left side surface of the second boss is recessed relative to the left side surface of the second side plate 1303 in the length direction of the optical module 200.

The left side of the first boss 1316 is provided with a third limiting surface 1317, and the left side of the second boss is provided with a fourth limiting surface. When the handle 2031 is installed to the lower shell part 202 through the first positioning column 1304 and the second positioning column 1305, and the handle 2031 rotates around the first positioning column 1304 and the second positioning column 1305, the third limiting surface 1317 and the fourth limiting surface limit the rotational movement of the handle 2031. This prevents the handle 2031 from detaching from the lower shell part 202 when the rotation angle becomes excessive.

The shell (e.g., the bottom plate 1301) is provided with a first guide column 1306 and a second guide column 1309. The first guide column 1306 is connected with the first side plate 1302, so that one side of the first guide column 1306 is flush with the first side plate 1302. Similarly, the second guide column 1309 is connected with the second side plate 1303, so that one side of the second guide column 1309 is flush with the second side plate 1303.

The bottom plate 1301 is further provided with mounting grooves, comprising a first mounting groove 1307 and a second mounting groove 1310. The first mounting groove 1307 and the second mounting groove 1310 are located between the first guide column 1306 and the second guide column 1309. Both the first mounting groove 1307 and the second mounting groove 1310 are recessed into the bottom plate 1301 and are spaced from each other, so that the portion of the bottom plate 1301 between the first mounting groove 1307 and the second mounting groove 1310 protrudes relative to the grooved areas. The first guide column 1306 is communicated with the first mounting groove 1307, and the first guide column 1306 is a side wall of the first mounting groove 1307. Similarly, the second guide column 1309 is connected with the second mounting groove 1310, and the second guide column 1309 is a side wall of the second mounting groove 1310.

The first mounting groove 1307 is provided with an opening on its left side and a first limiting surface 1308 on its right side. Structurally, the first mounting groove 1307 is defined as a U-shaped groove formed by the first guide column 1306, the first limiting surface 1308 and a side wall opposite to the first guide column 1306.

The second mounting groove 1310 is provided with an opening on its left side and a second limiting surface 1311 on its right side. Structurally, the second mounting groove 1310 is defined as a U-shaped groove formed by the second guide column 1309, the second limiting surface 1311 and one side wall opposite to the second guide column 1309.

In some embodiments, the lower shell part 202 further comprises a limiting plate disposed below the bottom plate 1301, and an accommodation cavity is formed between the limiting plate and the bottom plate 1301. For example, the limiting plate comprises a first limiting plate 1312 and a second limiting plate 1313. The first limiting plate 1312 and the second limiting plate 1313 are located below the bottom plate 1301. The first limiting plate 1312 and the second limiting plate 1313 extend along the length direction of the optical module 200, and a gap exists between the first limiting plate 1312 and the second limiting plate 1313. One side of the first limiting plate 1312 is fixedly connected with the first boss 1316, while maintaining a gap in the up-down direction between the first limiting plate 1312 and the bottom plate 1301, so, the first limiting plate 1312, the bottom plate 1301 and the first boss 1316 form a first accommodation cavity 1314. And the left side of the first accommodation cavity 1314 is provided with a first opening, so that the first accommodation cavity 1314 is communicated with the first mounting groove 1307.

One side of the second limiting plate 1313 is fixedly connected with the second boss, while maintaining a gap in the up-down direction between the second limiting plate 1313 and the bottom plate 1301, so, the second limiting plate 1313, the bottom plate 1301 and the second boss form a second accommodation cavity 1315. And the left side of the second accommodating cavity 1315 is provided with a second opening, so that the second accommodation cavity 1315 is communicated with the second mounting groove 1310.

In some embodiments, the first accommodation cavity 1314 is provided with a third opening facing toward the second limiting plate 1313, and the second accommodation cavity 1315 is provided with a fourth opening facing toward the first limiting plate 1312.

The unlocker 2032 can be inserted into the first accommodation cavity 1314 and the second accommodation cavity 1315 through the first opening, the second opening, the third opening and the fourth opening, so as to achieve vertical displacement restriction of the unlocker 2032, thereby preventing its detachment from the lower shell part 202.

The components on the lower shell part that are configured to constraining the sliding movement of the unlocker 2032 on the bottom plate 1301 may be generally referred to as an “unlocker movement guiding structure”, which is configured to define the travel limits of the unlocker 2032, wherein an accommodation cavity is formed for the unlocker 2032 to insert. In some embodiments, for example, the unlocker movement guiding structure may comprise a first limiting plate 1312, a bottom plate 1301, a first boss 1316, a second limiting plate 1313, and a second boss. In addition, based on the disclosure of the present application, a person skilled in the art may determine which components of the lower shell part may be considered to be part of the unlocker movement guiding structure.

The bottom plate 1301 is further provided with a positioning protrusion 2021, which is a wedge-shaped, non-movable feature formed on the bottom plate 1301. The positioning protrusion 2021 is aligned with the spring-lock hole on the cage 106 of the host computer 100. When the spring-lock hole cover engages with the positioning protrusion 2021, the optical module 200 and the cage 106 become mutually locked, preventing accidental disengagement.

The first limiting plate 1312 and the second limiting plate 1313 are located between the positioning protrusion 2021 and the left end of the lower shell part 202, and the positioning protrusion 2021 is located on the intermediate axis of the gap between the first limiting plate 1312 and the second limiting plate 1313, so that the gap size in the front-rear direction between the positioning protrusion 2021 and the first limiting plate 1312 and the gap size in the front-rear direction between the positioning protrusion 2021 and the second limiting plate 1313 are the same.

In some embodiments, the unlocker 2032 is arranged on the outside of the lower shell part 202 and is configured to slide in the left-right direction on the bottom plate 1301. When the unlocker 2032 moves rightward (i.e., toward the electrical port 204), the unlocker 2032 can mechanically displaces the spring latch on the cage 106, so that the cage 106 is separated from the positioning protrusion 2021, consequently, unlocking the optical module 200 from the cage 106.

In some embodiments, the upper shell part may comprise a cover plate and two opposing upper side plates. Correspondingly, the unlocking mechanism 203 may also be pivotally connected with the upper shell part. Depending on the position of the cage 106 in the host computer 100, the positioning protrusion 2021 that engages with the cage 106's lock may also be arranged on the upper shell part, while the unlocker 2032 may also slide along the cover plate. In some embodiments, the unlocker 2032 and the handle 2031 may be co-located on either the upper shell part or the lower shell part, or separately arranged on the upper shell part and the lower shell part.

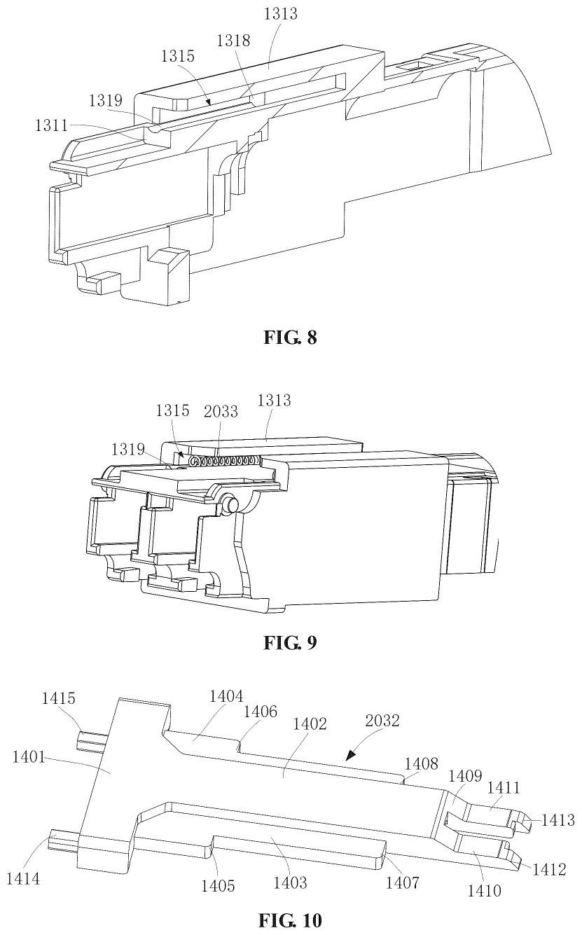

FIG. 8 is a partial sectional view of the lower shell part in an optical module according to some embodiments of the present disclosure, and FIG. 9 is a third structural schematic diagram from another perspective of the lower shell part in an optical module according to some embodiments of the present disclosure. As shown in FIG. 8 and FIG. 9, a fourth limiting plate 1318 is arranged in the second accommodation cavity 1315. The fourth limiting plate 1318 is parallel to the second limiting surface 1311, and maintains a predetermined spacing from the second limiting surface 1311. A second U-shaped groove 1319 is arranged on the bottom plate 1301 in the second accommodation cavity 1315, and the second U-shaped groove 1319 extends from the second limiting surface 1311 to the fourth limiting plate 1318.

The unlocking mechanism 203 further comprises a return spring 2033 arranged in the second accommodation cavity 1315—specifically positioned inside the second U-shaped groove 1319. In this configuration, one end of the return spring 2033 abuts against the fourth limiting plate 1318, and when the unlocker 2032 is inserted into the second accommodation cavity 1315, the other end of the return spring 2033 abuts against the unlocker 2032.

In the same way, a third limiting plate is arranged in the first accommodation cavity 1314. The third limiting plate is parallel to the first limiting surface 1308, and maintains a predetermined spacing from the first limiting surface 1308. The bottom plate 1301 of the accommodation cavity 1314 is provided with a U-shaped groove, in which the return spring 2033 is disposed. For example, a first U-shaped groove is disposed on the bottom plate 1301 in the accommodation cavity 1314, and the first U-shaped groove extends from the first limiting surface 1308 to the third limiting plate.

A return spring is arranged in the first accommodation cavity 1314, that is, the return spring 2033 is positioned inside the first U-shaped groove. In this configuration, one end of the return spring 2033 abuts against the third limiting plate, and when the unlocker 2032 is inserted into the first accommodation cavity 1314, the other end of the return spring 2033 abuts against the unlocker 2032.

When the unlocker 2032 is moved rightward by force, the return spring 2033 is compressed until the unlocker 2032 displaces the spring-lock hole engaged with the positioning protrusion 2021. Upon force removal, the unlocker 2032 moves leftward under the effect of the return spring 2033 until the unlocker 2032 is reset, thereby completing the unlocking of the optical module 200.

In some embodiments, the return spring 2033 is positioned within the first accommodation cavity 1314 and the second accommodation cavity 1315 through the first U-shaped groove and the second U-shaped groove 1319. The movement of the return spring 2033 is limited by the first accommodation cavity 1314 and the second accommodation cavity 1315, so as to prevent the return spring 2033 from detaching from the lower shell part 202.

FIG. 10 is a first structural schematic diagram of an unlocker in an optical module according to some embodiments of the present disclosure. As shown in FIG. 10, the unlocker 2032 comprises main plates. For example, main plates comprise a first main plate 1401 and a second main plate 1402. One end of the first main plate 1401 is fixedly connected with one end of the second main plate 1402, and the width of the first main plate 1401 in the front-rear direction is greater than the width of the second main plate 1402 in the front-rear direction. The top surface of the first main plate 1401 is flush with the top surface of the second main plate 1402, and the bottom surface of the first main plate 1401 and the second main plate 1402 lie on the same plane. This configuration causes the first main plate 1401 and the second main plate 1402 to form a T-shaped structure.

The central axis of the first main plate 1401 along the left-right direction coincides with the central axis of the second main plate along the left-right direction, that is, the distance between the front surface of the first main plate 1401 and the front surface of the second main plate 1402 and the distance between the rear surface of the first main plate 1401 and the rear surface of the second main plate 1402 are the same.

When the second main plate 1402 is connected with the first main plate 1401, the angle between the side of the second main plate 1402 and the side of the first main plate 1401 may be a right angle, and the side of the second main plate 1402 and the side of the first main plate 1401 may also be connected through an inclined plane.

The unlocker 2032 further comprises a first plug-in plate 1403 and a second plug-in plate 1404, and the first plug-in plate 1403 and the second plug-in plate 1404 are symmetrically arranged on both sides of the main plate. For example, the first plug-in plate 1403 and the second plug-in plate 1404 are symmetrically arranged on opposite sides of the second main plate 1402. The front surface of the first plug-in plate 1403 is fixedly connected with the front surface of the second main plate 1402, and the left surface of the first plug-in plate 1403 is fixedly connected with the right surface of the first main plate 1401. The top surface of the first plug-in plate 1403 is recessed relative to the top surface of the second main plate 1402, and the bottom surface of the first plug-in plate 1403 and the bottom surface of the second main plate 1402 lie on the same plane. In some examples, the first plug-in plate 1403 and the second plug-in plate 1404 are inserted into the accommodation cavity, with return spring 2033 disposed between the first plug-in plate 1403 and the inner wall of the accommodation cavity, and between the second plug-in plate 1404 and the inner wall of the accommodation cavity, respectively. The first plug-in plate 1403 may be inserted into the first accommodation cavity 1314 of the lower shell part 202, and the second plug-in plate 1404 may be inserted into the second accommodation cavity 1315 of the lower shell part 202, so as to realize the connection between the unlocker 2032 and the lower shell part 202.

In some embodiments, a groove is arranged on the rear surface of the first plug-in plate 1403. The groove extends from the right surface of the first plug-in plate 1403 toward the first main plate 1401. The right surface of the first plug-in plate 1403 comprises a first contact surface 1405 and a second contact surface 1407. The distance between the first contact surface 1405 and the first main plate 1401 in the left-right direction is smaller than the distance between the second contact surface 1407 and the first main plate 1401 in the left-right direction, that is, the second contact surface 1407 is positioned to the right of the first contact surface 1405. This design causes the first plug-in plate 1403 to function as an L-shaped plate, wherein the right surface of the second main plate 1402 is located to the right of the second contact surface 1407.

Since a groove is arranged on the rear surface of the first plug-in plate 1403, the rear surface of the first plug-in plate 1403 comprises a first rear surface and a second rear surface. The rear surface of the first main plate 1401 protrudes beyond the first rear surface, and the first rear surface protrudes beyond the second rear surface.

Similarly, the rear surface of the second plug-in plate 1404 is fixedly connected with the front surface of the second main plate 1402, and the left surface of the second plug-in plate 1404 is fixedly connected with the right surface of the first main plate 1401. The top surface of the second plug-in plate 1404 is recessed relative to the top surface of the second main plate 1402, and the bottom surface of the second plug-in plate 1404 and the bottom surface of the second main plate 1402 lie on the same plane.

A groove is arranged on the front surface of the second plug-in plate 1404. The groove extends from the right surface of the second plug-in plate 1404 toward the first main plate 1401. The right surface of the second plug-in plate 1404 comprises a third contact surface 1406 and a fourth contact surface 1408. The distance between the third contact surface 1406 and the first main plate 1401 in the left-right direction is smaller than the distance between the fourth contact surface 1408 and the first main plate 1401 in the left-right direction, that is, the fourth contact surface 1408 is positioned to the right of the third contact surface 1406. This design causes the second plug-in plate 1404 to function as an L-shaped plate, wherein the right surface of the second main plate 1402 is located to the right of the fourth contact surface 1408.

Since a groove is arranged on the front surface of the second plug-in plate 1404, the front surface of the second plug-in plate 1404 comprises a first front surface and a second front surface. The front surface of the first main plate 1401 protrudes beyond the first front surface, and the first front surface protrudes beyond the second front surface.

In some embodiments, since the top surfaces of the first plug-in plate 1403 and the second plug-in plate 1404 are recessed relative to the top surface of the second main plate 1402, the second main plate 1402 protrudes beyond the first plug-in plate 1403 and the second plug-in plate 1404.

In some embodiments, the right surface (also referred to as the unlocking end) of the main plate of the unlocker, for example the second main plate 1402, is connected to a connecting plate 1409. The bottom surface of the connecting plate 1409 is located on the same plane as the bottom surface of the second main plate 1402. The top surface of the connecting plate 1409 is inclined, that is, in the left-to-right direction, the distance between the top surface and the bottom surface of the connecting plate 1409 gradually decreases.

The connecting plate 1409 is provided with a groove. The groove penetrates through the top surface and the bottom surface of the connecting plate 1409, and extends from the right surface of the connecting plate 1409 toward the second main plate 1402. The length of the groove in the left-right direction may be smaller than the length of the connecting plate 1409 in the left-right direction.

The right surface of the connecting plate 1409 is connected with a first connecting arm 1410 and a second connecting arm 1411. A gap exists between the first connecting arm 1410 and the second connecting arm 1411, and the width of this gap is the same as the width of the groove on the connecting plate 1409. The left surface of the first connecting arm 1410 is fixedly connected with the right surface of the connecting plate 1409. The right surface of the first connecting arm 1410 is connected with the first wedge block 1412. The rear surface of the first wedge block 1412 is flush with the rear surface of the first connecting arm 1410, and the width of the first wedge block 1412 in the front-rear direction is smaller than the width of the first connecting arm 1410 in the front-rear direction.

The left surface of the second connecting arm 1411 is fixedly connected with the right surface of the connecting plate 1409. The right surface of the second connecting arm 1411 is connected with a second wedge block 1413. The front surface of the second wedge block 1413 is flush with the front surface of the second connecting arm 1411, and the width of the second wedge block 1413 in the front-rear direction is smaller than the width of the second connecting arm 1411 in the front-rear direction, that is, the distance between the first wedge block 1412 and the second wedge block 1413 is greater than the distance between the first connecting arm 1410 and the second connecting arm 1411.

In some embodiments, the first wedge block 1412 and second wedge block 1413 exhibit a gradually decreasing height dimension in the up-down direction along the left-to-right orientation. Additionally, a gap exists between the first wedge block 1412 and the second wedge block 1413, which is arranged opposite to the positioning protrusion 2021.

The distance between the first wedge block 1412 and the second wedge block 1413 is greater than the locking surface of the positioning protrusion 2021, that is, greater than the maximum width of the positioning protrusion 2021. Therefore, when the unlocker 2032 moves rightward toward the positioning protrusion 2021, the first wedge block 1412 and the second wedge block 1413 can bypass the positioning protrusion 2021 and extend further right. By utilizing the inclined upper surfaces of the first wedge block 1412 and the second wedge block 1413 to displace the spring-lock hole on the cage 106 from the positioning protrusion 2021, the cage 106 is detached from the positioning protrusion 2021, so that the unlocking is completed when the unlocker 2032 slides to the right.

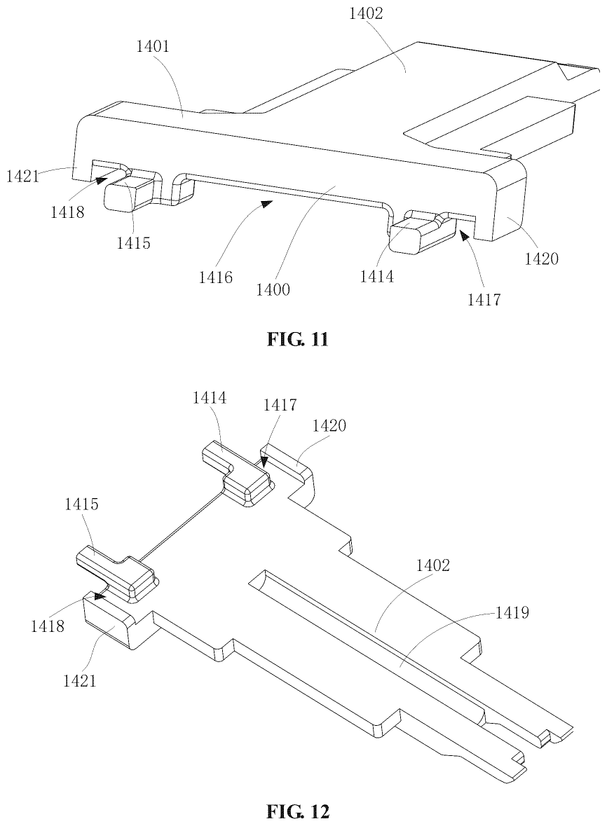

FIG. 11 is a second structural schematic diagram of an unlocker in an optical module according to some embodiments of the present disclosure and FIG. 12 is a third structural schematic diagram of an unlocker in an optical module according to some embodiments of the present disclosure. As shown in FIG. 11 and FIG. 12, the bottom surface of the unlocker 2032 is disposed thereon with a protrusion plate, and the bottom wall of the accommodation cavity (e.g., the bottom plate 1301) is disposed there on with a mounting groove containing a limiting surface. The protrusion plate is positioned within the mounting groove, with the limiting surface configured to abut against the protrusion plate so as to limit movement of the unlocker 2032.

In some embodiments, both sides of the unlocker 2032, such as the first main plate 1401, are provided with a first supporting plate 1420 and a second supporting plate 1421. The first supporting plate 1420 and the second supporting plate 1421 are symmetrically arranged about the central axis of the first main plate 1401 in the left-right direction. The top surfaces of the first supporting plate 1420 and the second supporting plate 1421 are connected with the top surface of the first main plate 1401, and a gap exists between the bottom surfaces of the first supporting plate 1420, the second supporting plate 1421 and the bottom surface of the first main plate 1401, so that the distance between the top surface of the first main plate 1401 and the bottom surface of the first main plate 1401 is smaller than the distance between the top surface of the first main plate 1401 and the bottom surfaces of the first supporting plate 1420 and the second supporting plate 1421.

The left side of the first main plate 1401 is provided with a force-bearing surface 1400. The protrusion plates comprise a first protrusion plate 1414 and a second protrusion plate 1415, both disposed on the bottom surface of the first main plate 1401. The first protrusion plate 1414 and the second protrusion plate 1415 are symmetrically arranged about the central axis of the first main plate 1401 in the left-right direction. The first protrusion plate 1414 and the second protrusion plate 1415 are positioned between the first supporting plate 1420 and the second supporting plate 1421, and the bottom surfaces of the first protrusion plate 1414 and the second protrusion plate 1415 are flush with the bottom surfaces of the first supporting plate 1420 and the second supporting plate 1421. The first protrusion plate 1414 and the second protrusion plate 1415 extend from the bottom surface of the first main plate 1401 in the direction away from the second main plate 1402, and the left surfaces of the first protrusion plate 1414 and the second protrusion plate 1415 protrudes beyond the force-bearing surface 1400.

Since gaps exist between the bottom surfaces of the first supporting plate 1420, the second supporting plate 1421, the first protrusion plate 1414, and the second protrusion plate 1415 relative to the bottom surface of the first main plate 1401, a first guide groove 1417 is formed between the first supporting plate 1420 and the first protrusion plate 1414. This first guide groove 1417 penetrates through the force-bearing surface 1400 and the right surface of the first main plate 1401, and is aligned with the first guide column 1306 on the lower shell part 202. When the unlocker 2032 is installed on the lower shell part 202, the first guide groove 1417 slides over the first guide column 1306.

A second guide groove 1418 is formed between the second supporting plate 1421 and the second protrusion plate 1415. This second guide groove 1418 penetrates through the force-bearing surface 1400 and the right surface of the first main plate 1401, and is aligned with the second guide column 1309 on the lower shell part 202. When the unlocker 2032 is installed on the lower shell part 202, the second guide groove 1418 slides over the second guide column 1309.

A third guide groove 1416 is formed between the first protruding plate 1414 and the second protrusion plate 1415. This third guide groove 1416 is aligned with the bottom plate 1301 located between the first mounting groove 1307 and the second mounting groove 1310 on the base of the lower shell part 202. When the unlocker 2032 is installed on the lower shell part 202, the third guide groove 1416 slides over the portion of shell (e.g., the bottom plate 1301) located between the first mounting groove 1307 and the second mounting groove 1310.

In some embodiments, when the unlocker 2032 is installed on the lower shell part 202, the first guide groove 1417 slides over the first guide column 1306, the second guide groove 1418 slides over the second guide column 1309, and the third guide groove 1416 slides over the bottom plate 1301 between the first mounting groove 1307 and the second mounting groove 1310, such that, the first protrusion plate 1414 is located in the first mounting groove 1307, and the second protrusion plate 1415 is located in the second mounting groove 1310, enabling the unlocker 2032 to move left-right along the first guide column 1306 and second guide column 1309, thereby realizing the movement of the unlocker 2032 on the lower shell part 202.

In some embodiments, in order to ensure that the unlocker 2032 moves strictly along the left-right direction on the lower shell part 202, a guide groove 1419 is arranged on the bottom surface of the second main plate 1402, where the central axis of the guide groove 1419 in the left-right direction coincides with the central axis of the second main plate 1402 in the left-right direction, and the guide groove 1419 is communicated with the groove on the connecting plate 1409; a guide column is arranged on the bottom plate 1301 between the first limiting plate 1312 and the second limiting plate 1313, where the guide groove 1419 is aligned with this guide column. When the unlocker 2032 is installed on the lower shell part 202, the guide groove 1419 slides over the guide column, so that the unlocker 2032 can move left and right along the guide column to preventing lateral deviation.

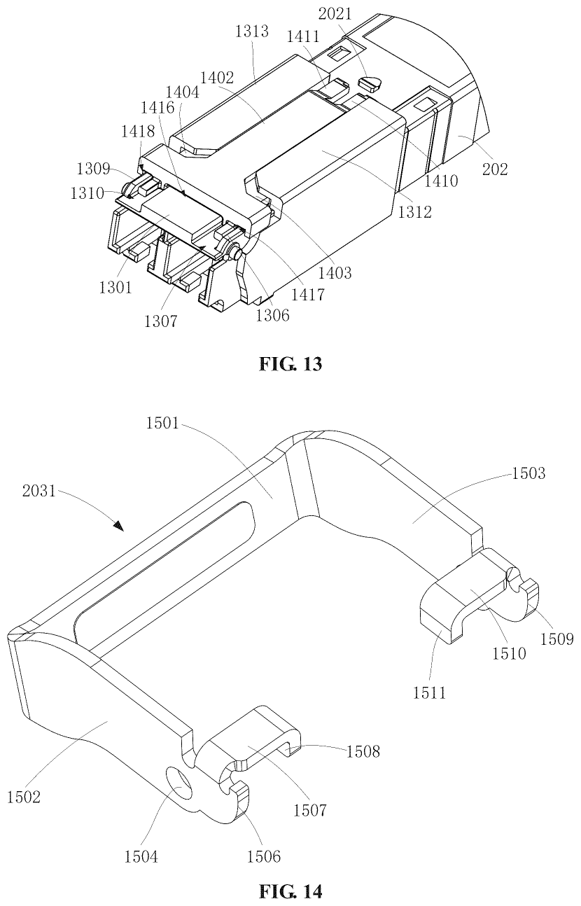

FIG. 13 is a partial assembly schematic diagram of a lower shell part and an unlocker in an optical module according to some embodiments of the present disclosure. As shown in FIG. 13, when the unlocker 2032 is installed on the lower shell part 202, the second main plate 1402 of the unlocker 2032 is aligned with the gap between the first limiting plate 1312 and the second limiting plate 1313, the first plug-in plate 1403 is aligned with the first opening on the left side of the first accommodation cavity 1314, the second plug-in plate 1404 is aligned with the second opening on the left side of the second accommodation cavity 1315, and then the unlocker 2032 is moved from left to right, causing the second main plate 1402 to insert into the gap between the first limiting plate 1312 and the second limiting plate 1313, the first plug-in plate 1403 to insert into the first accommodation cavity 1314, and the second plug-in plate 1404 to insert into the second accommodation cavity 1315. Then the unlocker 2032 is continued moving rightward until the first guide groove 1417 slides over the first guide column 1306, the second guide groove 1418 slides over the second guide column 1309, the third guide groove 1416 slides over the bottom plate 1301 between the first mounting groove 1307 and the second mounting groove 1310, the first protrusion plate 1414 is positioned within the first mounting groove 1307, and the second protrusion plate 1415 is positioned within the second mounting groove 1310.

In some embodiments, when the first plug-in plate 1403 and the second plug-in plate 1404 are inserted into the accommodation cavity, a return spring 2033 is connected between the first contact surface 1405 of the first plug-in plate 1403 and the inner wall of the accommodation cavity, and another return spring 2033 is connected between the third contact surface 1406 of the second plug-in plate 1404 and the inner wall of the accommodation cavity. For example, after the first plug-in plate 1403 is inserted into the first accommodation cavity 1314, one end of the return spring 2033 inside the first accommodation cavity 1314 abuts against the third limiting plate, and the other end of the return spring 2033 abuts on the first contact surface 1405 of the first plug-in plate 1403, so as to realize the transmission of force between the return spring 2033 and the unlocker 2032.

After the second plug-in plate 1404 is inserted into the second accommodation cavity 1315, one end of the return spring 2033 inside the second accommodation cavity 1315 abuts against the fourth limiting plate 1318, and the other end of the return spring 2033 abuts against the third contact surface 1406 of the second plug-in plate 1404, so as to realize the transmission of force between the return spring 2033 and the unlocker 2032.

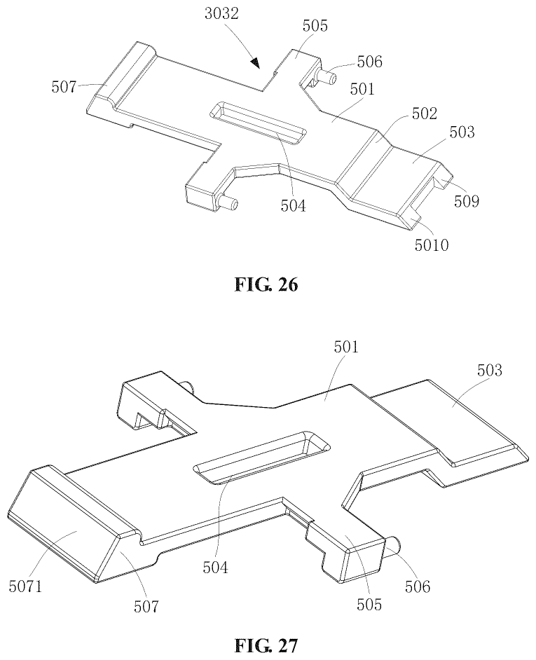

In some examples, mounting columns (refer to the second mounting column 506 in FIG. 26 for reference) may extend from the first contact surface 1405 and the third contact surface 1406, and the return spring 2033 may be sleeved over said mounting columns.

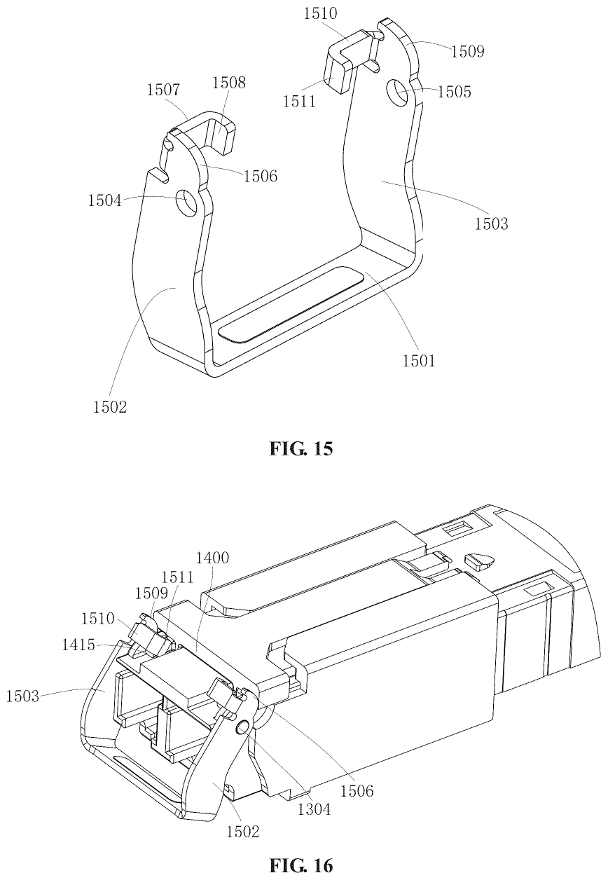

FIG. 14 is a first structural schematic diagram of a handle in an optical module according to some embodiments of the present disclosure, and FIG. 15 is a second structural schematic diagram of a handle in an optical module according to some embodiments of the present disclosure. As shown in FIG. 14 and FIG. 15, the handle 2031 comprises a first cantilever 1502, a second cantilever 1503 and a crossbeam 1501. The first cantilever 1502 and the second cantilever 1503 are arranged opposite each other, and the two ends of the crossbeam 1501 are fixedly connected with the first cantilever 1502 and the second cantilever 1503, respectively. Therefore, the handle 2031 is a U-shaped structure formed by the crossbeam 1501, the first cantilever 1502 and the second cantilever 1503.

The first cantilever 1502 is provided with a first positioning hole 1504, and the first positioning hole 1504 is aligned with the first positioning column 1304 on the lower shell part 202. When the handle 2031 is installed on the lower shell part 202, the first positioning column 1304 is inserted into the first positioning hole 1504.

The other end of the first cantilever 1502 is provided with a first connecting beam 1507 and a first anti-detachment hook 1508. One end of the first connecting beam 1507 is fixedly connected with the first cantilever 1502, and the other end of the first connecting beam 1507 is fixedly connected with the first anti-detachment hook 1508. The first anti-detachment hook 1508 is parallel to the first cantilever 1502. The combination of the first cantilever 1502, first connecting beam 1507, and first anti-detachment hook 1508 forms a first U-shaped anti-detachment structure.

When the handle 2031 is installed on the lower shell part 202, the first guide column 1306 and the first protrusion plate 1414 are located inside the first U-shaped anti-detachment structure, and the distance between the first cantilever 1502 and the first anti-detachment hook 1508 (the width dimension of the first connecting beam 1507) is greater than the sum of the width dimensions of the first guide column 1306 and the first protrusion plate 1414, that is, there is a gap between the first protrusion plate 1414 and the first anti-detachment hook 1508.

The other end surface of the first cantilever 1502 is designed as an arc surface, serving as a first unlocking surface 1506. The distance between the first unlocking surface 1506 and the crossbeam 1501 is greater than the distance between the first connecting beam 1507 and the crossbeam 1501. The first unlocking surface 1506 is in close contact with the force-bearing surface 1400 of the unlocker 2032. The force of the handle 2031 is applied to the unlocker 2032 through the first unlocking surface 1506 to make the unlocker 2032 move on the lower shell part 202.

In the same way, the second cantilever 1503 is provided with a second positioning hole 1505, and the second positioning hole 1505 is aligned with the second positioning column 1305 on the lower shell part 202. When the handle 2031 is installed on the lower shell part 202, the second positioning column 1305 is inserted into the second positioning hole 1505.

The other end of the second cantilever 1503 is provided with a second connecting beam 1510 and a second anti-detachment hook 1511. One end of the second connecting beam 1510 is fixedly connected with the second cantilever 1503, and the other end of the second connecting beam 1510 is fixedly connected with the second anti-detachment hook 1511. The second anti-detachment hook 1511 is parallel to the second cantilever 1503. The combination of the second cantilever 1503, the second connecting beam 1510 and the second anti-detachment hook 1511 forms a second U-shaped anti-detachment structure.

When the handle 2031 is installed on the lower shell part 202, the second guide column 1309 and the second protrusion plate 1415 are located inside the second U-shaped anti-detachment structure, and the distance between the second cantilever 1503 and the second anti-detachment hook 1511 (the width dimension of the second connecting beam 1510) is greater than the sum of the width dimensions of the second guide column 1309 and the second protrusion plate 1415, that is, there is a gap between the second protrusion plate 1415 and the second anti-detachment hook 1511.

The other end surface of the second cantilever 1503 is designed as an arc surface, serving as a second unlocking surface 1509. The distance between the second unlocking surface 1509 and the crossbeam 1501 is greater than the distance between the second connecting beam 1510 and the crossbeam 1501. The second unlocking surface 1509 is in close contact with the force-bearing surface 1400 of the unlocker 2032. The force of the handle 2031 is applied to the unlocker 2032 through the second unlocking surface 1509 to make the unlocker 2032 move on the lower shell part 202.

In some embodiments, because there is a gap between the first protrusion plate 1414 and the first anti-detachment hook 1508, and there is a gap between the second protrusion plate 1415 and the second anti-detachment hook 1511, so, when a user applies off-center force to the handle 2031, (e.g., gripping only the left or right side), the handle 2031 tilts toward one side of the lower shell part 202. In this case, the first anti-detachment hook 1508 may abut against the first protrusion plate 1414, or the second anti-detachment hook 1511 may abut against the second protrusion plate 1415, so that the handle 2031 is avoided from detaching from the first positioning column 1304 and the second positioning column 1305 on the lower shell part 202.

In some embodiments, the structure of the positioning column combined with the positioning hole may be referred to as a pivotable positioning assembly, which comprises a first pivotable positioning member (e.g., the first and second positioning columns 1304 and 1305) and a second pivotable positioning member (e.g., the first and second positioning holes 1504 and 1505). In some embodiments, a positioning column may also be referred to as a positioning pin. The arranged positions of the first pivotable positioning member and the second pivotable positioning member are interchanged. For example, the first and second positioning columns 1304 and 1305 are arranged on the first and second cantilevers 1502 and 1503 of the handle 2031, and the first and second positioning holes 1504 and 1505 are arranged on the first and second side plates 1302 and 1303 of the lower shell part 302.

FIG. 16 is a partial assembly schematic diagram of a lower shell part, a handle and an unlocker in an optical module according to some embodiments of the present disclosure. As shown in FIG. 16, after the unlocker 2032 is installed on the lower shell part 202, the handle 2031 is snapped into the first positioning column 1304 and the second positioning column 1305 of the lower shell part 202 via the first positioning hole 1504 and the second positioning hole 1505; the first guide column 1306 and the first protrusion plate 1414 are positioned within the first U-shaped anti-detachment structure, and the second guide column 1309 and the second protrusion plate 1415 are positioned within the second U-shaped anti-detachment structure. The first unlocking surface 1506 and the second unlocking surface 1509 of the handle 2031 maintain close contact with the force-bearing surface 1400 of the unlocker 2032 to install the handle 2031 on the lower shell part 202. The handle 2031 can rotate around the first positioning column 1304 and the second positioning column 1305. When the handle 2031 rotates, the movement of the first unlocking surface 1506 and the second unlocking surface 1509 drives the movement of the unlocker 2032.

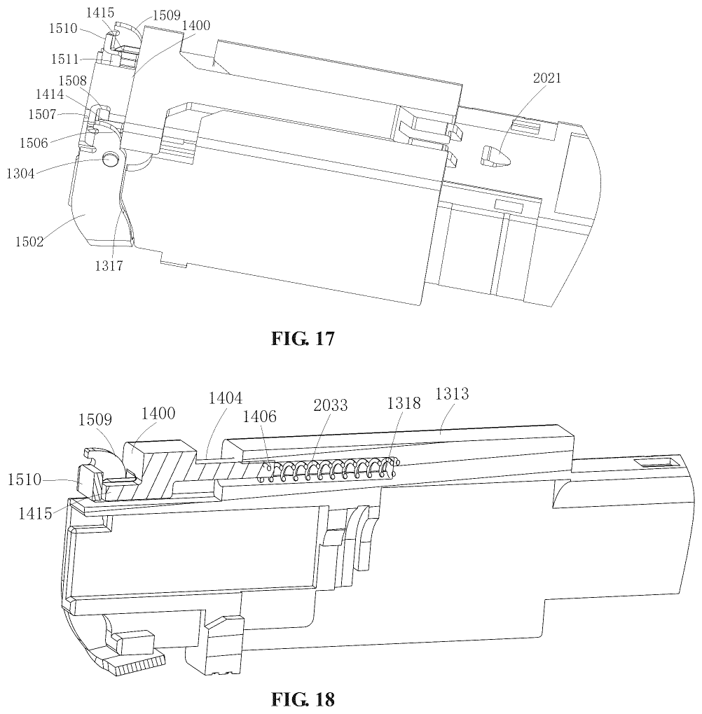

FIG. 17 is a schematic diagram of a locked state of an optical module according to some embodiments of the present disclosure, and FIG. 18 is a sectional view of a locked state of an optical module according to some embodiments of the present disclosure. As shown in FIG. 17 and FIG. 18, after the unlocker 2032 and the handle 2031 are respectively assembled on the lower shell part 202 and when the handle 2031 is in the vertical position, the optical module 200 is in a locked state, the return spring 2033 is in a neutral state, and the force-bearing surface 1400 of the unlocker 2032 presses against the first unlocking surface 1506 and the second unlocking surface 1509 of the handle 2031, so that the unlocker 2032 remains in secure contact with the handle 2031 without loosening. There is a preset distance between the right surface of the first main plate 1401 of the unlocker 2032 and the left surfaces of the first accommodation cavity 1314 and the second accommodation cavity 1315, and the distance between the extended first wedge block 1412, second wedge block 1413 of the unlocker 2032 and the positioning protrusion 2021 meets protocol specifications.

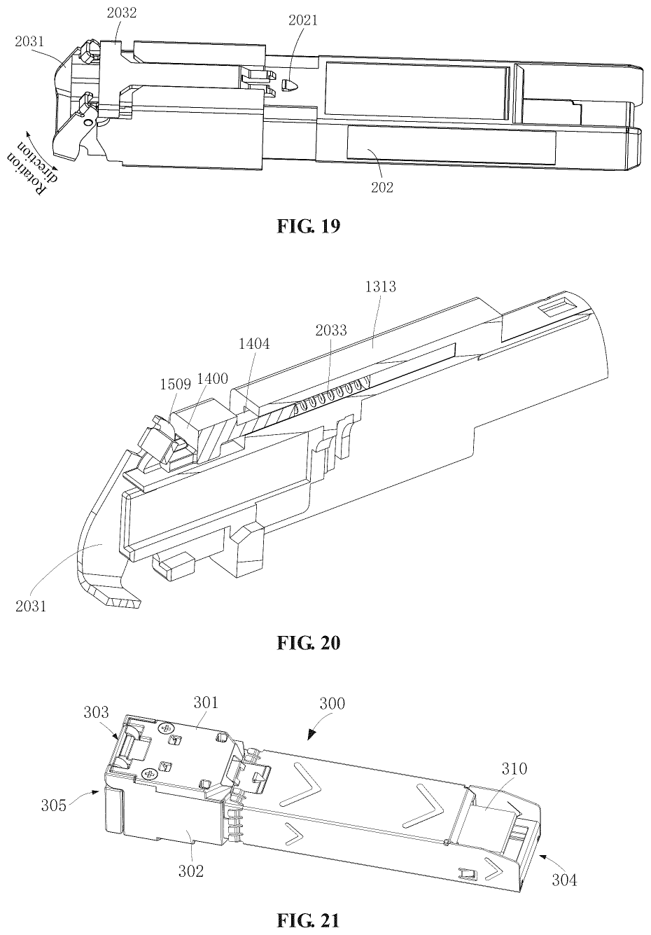

FIG. 19 is a schematic diagram of an unlocked state of an optical module according to some embodiments of the present disclosure; FIG. 20 is a sectional view of an unlocked state of an optical module according to some embodiments of the present disclosure; As shown in FIG. 19 and FIG. 20, when a user wants to unlock the optical module 200, he/she grabs the crossbeam 1501 of the handle 2031, rotates the handle 2031 from bottom to top (in the rotation direction shown in FIG. 19), and the first unlocking surface 1506 and the second unlocking surface 1509 of the handle 2031 abuts against the force-bearing surface 1400 of the unlocker 2032, driving the unlocker 2032 to move to the right. When the handle 2031 is in a horizontal state, the first limiting surface 1308 abuts against the first protrusion plate 1414 of the unlocker 2032, the second limiting surface 1311 abuts against the second protrusion plate 1415, the left side surface of the first accommodation cavity 1314 and the left side surface of the second accommodation cavity 1315 abuts against the right side surface of the first main plate 1401, so that the unlocker 2032 is limited, the unlocker 2032 is avoided from continuing to move to the right, and the moving range of the unlocker 2032 is limited.

At this moment, the locked surface of the positioning protrusion 2021 is located between the first wedge block 1412 and the second wedge block 1413 of the unlocker 2032, and the first wedge block 1412 and the second wedge block 1413 displace the spring-lock hole on the cage 106, so that the cage 106 is disengaged from the positioning protrusion 2021 to unlock the optical module 200. When the optical module 200 is unlocked, the handle 2031 is pulled outward to smoothly pull the optical module 200 out of the cage 106.

When the user releases the crossbeam 1501 of the handle 2031, the return spring 2033, which is in a compressed state, causes the unlocker 2032 to move to the left under its restoring force. This movement of the unlocker 2032 drives the handle 2031 to rotate from top to bottom, so that the handle 2031 realizes automatic reset.

In some embodiments, the first boss 1316 on the lower shell part 202 protrudes from the first side plate 1302, the second boss protrudes from the second side plate 1303, and the first boss 1316 is disposed with a third limiting surface 1317, which is located opposite to the first cantilever 1502 of the handle 2031. Similarly, the second boss has a fourth limiting surface that is located opposite to the second cantilever 1503 of the handle 2031. When the handle 2031 rotates under the force of the return spring 2033, the third limiting surface 1317 and the fourth limiting face are limited to the handle 2031, so that the handle 2031 is prevented from continuing to rotate, preventing the unlocker 2032 from continuing to move to the left, and limiting the moving range of the unlocker 2032.

In some embodiments of the present disclosure, when assembling the optical module 200, the unlocker 2032 is first assembled to the bottom plate 1301 of the lower shell part 202, wherein the unlocker 2032 can move left and right on the bottom plate 1301; then the return spring 2033 is fixed between the unlocker 2032 and the first accommodation cavity 1314 and the second accommodation cavity 1315; tightly matched under the action of the return spring 2033, the unlocker 2032 is not easy to loosen from the lower shell part 202; then the handle 2031 is snapped into the lower shell part 202 through the first positioning column 1304 and the second positioning column 1305, wherein the first unlocking surface 1506 and the second unlocking surface 1509 of the handle 2031 are in close contact with the force-bearing surface 1400 of the unlocker 2032, so that the handle 2031 can rotate around the first positioning column 1304 and the second positioning column 1305 under the action of external force, and the unlocker 2032 can be driven to move to the right on the lower shell part 202 when the handle 2031 rotates.

When the handle 2031 is in a vertical state, the optical module 200 is in a locked state. When the optical module 200 needs to be unlocked, the handle 2031 is lifted and rotated upward. The unlocker 2032 is in close contact with the force-bearing surface 1400 through the first unlocking surface 1506 and the second unlocking surface 1509. Under the force applied by the handle 2031, the unlocker 2032 moves to the right along the first guide column 1306 and the second guide column 1309 of the lower shell part 202, and displaces the spring sheet on the cage 106 through the first wedge block 1412 and the second wedge block 1413 of the unlocker 2032. During this process, the return spring 2033 changes from a neutral state to a compressed state, and the unlocker 2032 is subjected to an increased elastic force to the left by the return spring 2033.

When the handle 2031 rotates to the horizontal position, the unlocker 2032 moves to the right to the limit position, the first wedge block 1412 and the second wedge block 1413 of the unlocker 2032 extend rightward beyond the positioning protrusion 2021, and the spring sheet on the cage 106 is displaced by using the inclined plane on the upper side of the wedge block, so that the spring-lock hole on the cage 106 is disengaged from the positioning protrusion 2021, thereby completing the unlocking.

After unlocking is completed and the handle 2031 is released, the external force acting on the handle 2031 disappears, and the unlocker 2032 moves to the left under the action of the return spring 2033, so that the handle 2031 that is in close contact with the unlocker 2032 returns to its original position under the pushing force of the force-bearing surface 1400, thereby completing the unlocking process.

In the present disclosure, the unlocking surface of the handle and the positioning hole are designed on the same cantilever of the handle, and the processing accuracy of the distance size from the positioning hole to the unlocking surface is higher, ensuring a better motion stroke of the unlocker to guarantee the unlocking function to be reliable. The force applied to the unlocking surface and the unlocker is shear force, and the rigidity of the handle material itself resists the reaction force from the unlocker, so the handle is not easy to be deformed. The crossbeam of the handle is only used to connect the anti-detachment hook of the cantilever, and does not transmit the force between the handle and the unlocker, so that the crossbeam is not easy to be deformed and the unlocking adaptability is stronger.

The electrical module, also known as the optical-to-electrical module, has the characteristics of low power consumption, high performance and compact design. It is mainly used in short-distance data transmission. The optical module, also known as the optical fiber module, is an optical device that can transmit and receive analog signals, in which the electrical signal is converted into an optical signal after passing through the transmitter end of the optical module, or the optical signal is converted into an electrical signal after passing through the receiving end of the optical module, so as to achieve photoelectric conversion.

The electrical module is a low-power consumption module with interface capabilities, located in the network cable interface 104 of the host computer 100. The network cable 103 is inserted into the electrical module to realize the electrical connection between the local information processing device 2000 and the host computer 100 through the combined pathway of the network cable 103 and the electrical module.

At present, the electrical connector used by the electrical module in the SFP electrical module is relatively larger in size, and the circuit board and the electrical connector are assembled by adopting the mode of inserting from the network port of the electrical module, and the unlocking mechanism can only be assembled after the circuit board is installed.

However, the handle of the unlocking mechanism mostly adopts the mode of non-rebound, and the unlocking mechanism is not easy to be disassembled. The unlocking feel is poor, and it is not easy to operate.

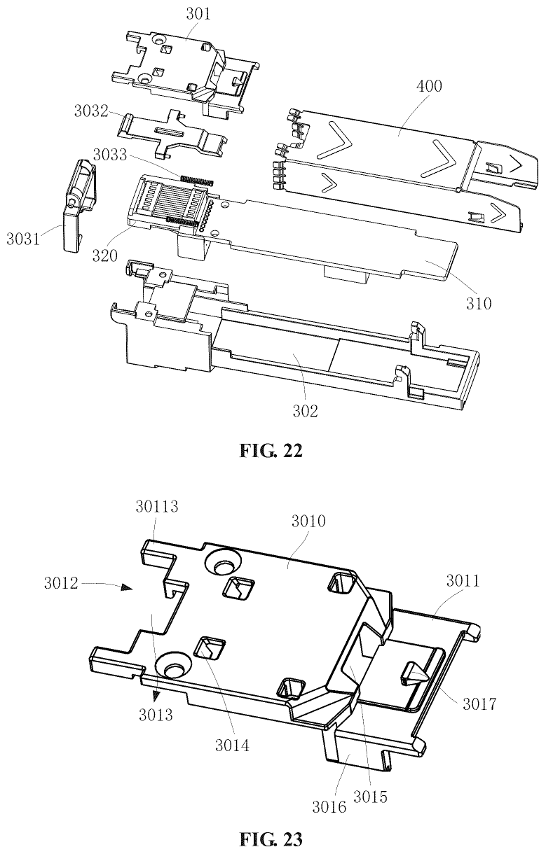

FIG. 21 is a structural schematic diagram of an electrical module according to some embodiments, and FIG. 22 is an exploded structural schematic diagram of an electrical module according to some embodiments. As shown in FIG. 21 and FIG. 22, the electrical module 300 has a shell, which comprises a circuit board 310 arranged in the shell and a device arranged on the circuit board 310 and electrically connected to it.

The shell comprises an upper shell part and a lower shell part 302, and the upper shell part is covered by the lower shell part 302 to form the shell with the opening 304 and the opening 305, wherein the outer contour of the shell is generally rectangular cuboid-shaped.

In some embodiments, the lower shell part 302 comprises a bottom plate and two lower side plates located on both sides of the bottom plate and perpendicular to the bottom plate. The upper shell part comprises a cover plate 301 and two upper side plates located on two sides of the cover plate 301 and perpendicular to the cover plate 301, and is combined with two lower side plates by two upper side plates to achieve that the upper shell part is covered on the lower shell part 302.

The direction of the connection of the two openings 304 and 305 may be consistent with the length direction of the electrical module 300 or inconsistent with the length direction of the electrical module 300. For example, the opening 304 is located at the end of the electrical module 300 (at the right end of FIG. 21), and the opening 305 is also located at the end of the electrical module 300 (at the left end of FIG. 21). Alternatively, the opening 304 is located at the end of the electrical module 300, and the opening 305 is located at the side of the electrical module 300. The opening 304 is an electrical port, and the gold finger of the circuit board 310 stretches out from the electrical port and is inserted into the host computer 100 (for example, an optical network terminal). The opening 305 is also an electrical port, which is configured to access an external network cable 103 so that the network cable 103 is connected to an electrical connector 320 inside the electrical module 300.

The assembly mode of combining the upper shell part and the lower shell part 302 is adopted, so that the circuit board 310 and other devices are conveniently installed in the shell, and the upper shell part and the lower shell part 302 form encapsulation protection for these devices. In addition, when assembling devices such as circuit board 310, it is convenient to deploy the positioning components, heat dissipation components, and electromagnetic shielding components of these devices, which is conducive to automated production.

In some embodiments, the upper shell part and the lower shell part 302 are generally made of metal materials, which is conducive to electromagnetic shielding and heat dissipation.

In some embodiments, the electrical module 300 further comprises an unlocking mechanism 303 located outside its shell, and the unlocking mechanism 303 is configured to achieve a fixed connection between the electrical module 300 and the host computer 100, or to release the fixed connection between the electrical module 300 and the host computer 100.

With regard to the circuit board 310, the above description of the circuit board for the optical module is also applicable to the circuit board 310 for the electrical module, and will not be repeated here. In order to distinguish it from the cage for the optical module in the host computer 100, the cage for the electrical module in the host computer 100 can also be called a shielding cage 400.

In some embodiments, one end of the electrical connector 320 is electrically connected to the circuit board 310 through a pin, and the mutual signal transmission is achieved through the wiring on the circuit board 310. The other end of the electrical connector 320 is connected to the network cable 103 to achieve an electrical connection between the network cable 103 and the electrical module 300. After the electrical connector 320 is electrically connected to the circuit board 310, it is assembled into the lower shell part 302 to support and fix the circuit board 310 and the electrical connector 320 through the lower shell part 302.

The unlocking mechanism 303 comprises a handle 3031 and an unlocker 3032, the handle 3031 is rotated and connected to the lower shell part 302, the unlocker 3032 is arranged on the inner side of the cover plate 301, and when the handle 3031 rotates, the unlocker 3032 is driven to move left and right on the cover plate 301, so that the electrical module 300 and the shielding cage 400 of the host computer are locked or unlocked.

In some embodiments of the present disclosure, the left-right direction (also referred to as the first direction) corresponds to the plug-in direction of the electrical module 300, where the pluggable end for engaging with the host computer 100 is located at the right end. The front-rear direction (also referred to as the second direction) refers to the direction perpendicular to the left-right direction in the horizontal plane, wherein, when the electrical module 300 is oriented with its top shell facing upward and its pluggable end at the right, the visible face in this view is defined as the front side, and the rear side is the opposite surface.

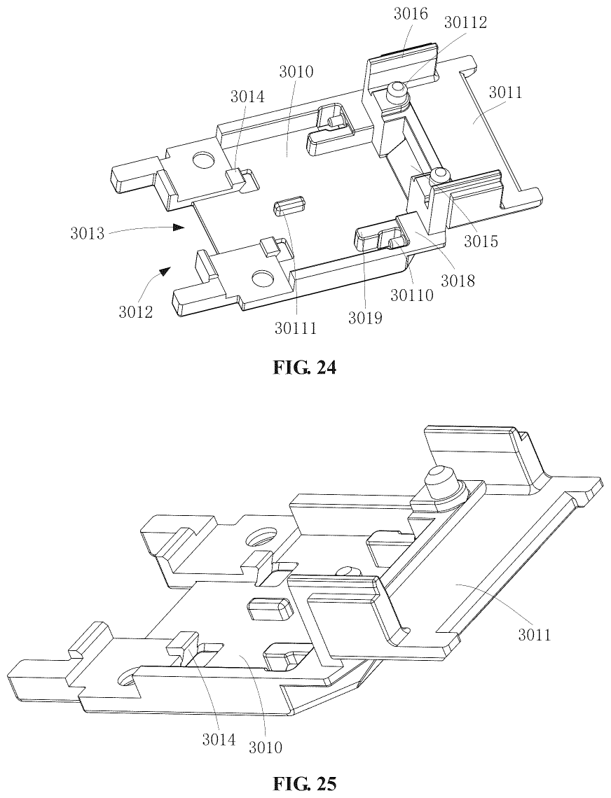

FIG. 23 is a first structural schematic diagram of a cover plate in an electrical module according to some embodiments of the present disclosure, FIG. 24 is a second structural schematic diagram of a cover plate in an electrical module according to some embodiments of the present disclosure, and FIG. 25 is a third structural schematic diagram of a cover plate in an electrical module according to some embodiments of the present disclosure. As shown in FIG. 23, FIG. 24 and FIG. 25, the cover plate 301 comprises a first supporting plate 3010 and a second supporting plate 3011. The first supporting plate 3010 is fixedly connected to the second supporting plate 3011 through a connecting plate (also referred to as a cover connecting plate), and along the left-right direction, the connecting plate is inclined, that is, the top surface of the first supporting plate 3010 protrudes from the top surface of the second supporting plate 3011, so that an accommodation cavity for accommodating the unlocker 3032 is formed between the first supporting plate 3010 and the lower shell part 302. The connecting plate is provided with a through hole 3015, and the inner wall of the first supporting plate 3010 is connected to the top surface of the second supporting plate 3011 through the through hole 3015.

A positioning protrusion 3017 is arranged on the top surface of the second supporting plate 3011, the positioning protrusion 3017 is a wedge protrusion on the top surface of the second supporting plate 3011, and is an inactive part. The positioning protrusion 3017 is arranged opposite to the spring-lock hole on the shielding cage 400 of the host computer, and when the spring-lock hole cover engages with the positioning protrusion 3017, the electrical module 300 and the shielding cage 400 are mutually locked, and it is not easy to get out of lock.

In some embodiments, the unlocker 3032 is arranged on the inner side of the cover plate 301, one end of the unlocker 3032 passes through the through hole 3015 and is located on the top surface of the second supporting plate 3011, and the unlocker 3032 can move left and right on the inner side of the cover plate 301. When the unlocker 3032 moves to the right, the unlocker 3032 can displace the spring sheet on the shielding cage 400, so that the shielding cage 400 is separated from the positioning protrusion 3017, thereby the electrical module 300 and the shielding cage 400 are unlocked.

A first groove 3012 and a second groove 3013 are provided at one end of the first supporting plate 3010 away from the second supporting plate 3011. The first groove 3012 extends from the left side of the first support plate 3010 to the right side, and an opening is arranged on the left side of the first groove 3012, so that the first groove 3012 comprises an opposite side wall 30113 and a first connecting arm. Both ends of the first connecting arm are respectively connected to two side walls 30113, so that the first groove 3012 forms a U-shaped groove.

The second groove 3013 extends from the first connecting arm toward the second supporting plate 3011, an opening is arranged on the first connecting arm, the first groove 3012 is connected to the second groove 3013 through this opening, so that the second groove 3013 comprises two opposite sides of the wall and the second connecting arm, and the second connecting arm is parallel to the first connecting arm, so that the second groove 3013 forms a U-shaped groove.

In some embodiments, the unlocker 3032 is installed to the inner side of the cover plate 301 through the first groove 3012 and the second groove 3013, and the unlocker 3032 moves left and right in the first groove 3012 and the second groove 3013 to achieve the locking or unlocking of the electrical module 300 and the shielding cage 400 of the host computer.

The first supporting plate 3010 is provided with two opposite side plates, and the side plates extend from the top surface of the first supporting plate 3010 in the direction of the lower shell part 302. A fixed block 3018 is arranged on the bottom surface of the first supporting plate 3010. The fixed block 3018 is perpendicular to the side plate on the first supporting plate 3010, one end of the fixed block 3018 is fixedly connected to one side plate, and the other end extends in the direction of the opposite other side plate. A limiting plate 3019 is further arranged on the bottom surface of the first supporting plate 3010, one end of the limiting plate 3019 is fixedly connected to the other end of the fixed block 3018, the limiting plate 3019 is parallel to the side plate on the first supporting plate 3010, and there is a gap between the limiting plate 3019 and the side plate, so that one side plate, the fixed block 3018 and the limiting plate 3019 form a U-shaped groove.

The fixed block 3018 is provided with a first mounting column 30110, the first mounting column 30110 extends from the fixed block 3018 to the direction of the first groove 3012, and the first mounting column 30110 is located in a U-shaped groove formed by the side plate, the fixed block 3018 and the limiting plate 3019.

In some embodiments, a return spring 3033 can be sleeved on the first mounting column 30110, one end of the return spring 3033 is connected to the first mounting column 30110, and the other end of the return spring 3033 is connected to the unlocker 3032, so that the return spring 3033 is not easy to loosen. When the unlocking mechanism 303 is in an unlocked state, the unlocker 3032 can automatically rebound under the action of the return spring 3033.

In some embodiments, the return spring 3033 is encapsulated in the U-shaped groove formed by the side plate of the cover plate 301, the fixed block 3018 and the limiting plate 3019 through the first mounting column 30110, so that the return spring 3033 is not easy to loosen. The inner diameter of the U-shaped groove is greater than the outer diameter of the return spring 3033, so that the return spring 3033 is compressed and stretched freely, thereby the unlocker 3032 moves smoothly left and right under the guidance of the guide column 30111, and the final unlocking movement is smoother and more accurate.

In some embodiments, two opposite first mounting columns 30110 are arranged on the bottom surface of the first supporting plate 3010, so that two return springs 3033 are arranged between the cover plate 301 and the unlocker 3032. And the two return springs 3033 are arranged opposite to each other, so that the balance between the unlocker 3032 and the cover plate 301 is ensured, and the unlocker 3032 rebounds faster under the action of the two return springs 3033.

The bottom surface of the first supporting plate 3010 is also provided with a limiting recess. The limiting recess comprises a limiting hole and a limiting inclined plate 3014, one end of the limiting inclined plate 3014 is fixedly connected to an edge of the limiting hole, the limiting inclined plate 3014 passes through the limiting hole, the limiting inclined plate 3014 is inclined by the top of the first supporting plate 3010 in the direction of the lower shell part 302, and the inclined plane of the limiting inclined plate 3014 is oriented towards the second supporting plate 3011.

When the unlocker 3032 is installed to the inner side of the cover plate 301, the unlocker 3032 can be limited through the limiting inclined plate 3014, an inclined recess form is adopted, and the unlocker 3032 is not easy to be loosened from the cover plate 301.

In some embodiments, a guide column 30111 is arranged on the bottom surface of the first supporting plate 3010, and the guide column 30111 is extended and arranged along the left-right direction, so that the unlocker 3032 moves left and right under the guidance of the guide column 30111 when the unlocker 3032 is installed to the inner side of the cover plate 301.

In some embodiments, two limiting recesses are symmetrically arranged on the bottom surface of the first supporting plate 3010, the two limiting recesses are located between the two first mounting columns 30110, and the guide column 30111 is located between the two limiting recesses.

In some embodiments, two opposite flat plates 3016 are arranged on the second supporting plate 3011, the two ends of the second supporting plate 3011 are fixedly connected to the two flat plates 3016 respectively, the flat plate 3016 and the second supporting plate 3011 are perpendicular to each other, and the flat plate 3016 extends from the bottom surface of the second supporting plate 3011 toward the lower shell part 302.

The bottom surface of the second supporting plate 3011 is provided with two opposite positioning columns 30112, the positioning column 30112 extends from the bottom surface of the second supporting plate 3011 toward the lower shell part 302, and the two positioning columns 30112 are located on both sides of the through hole 3015.

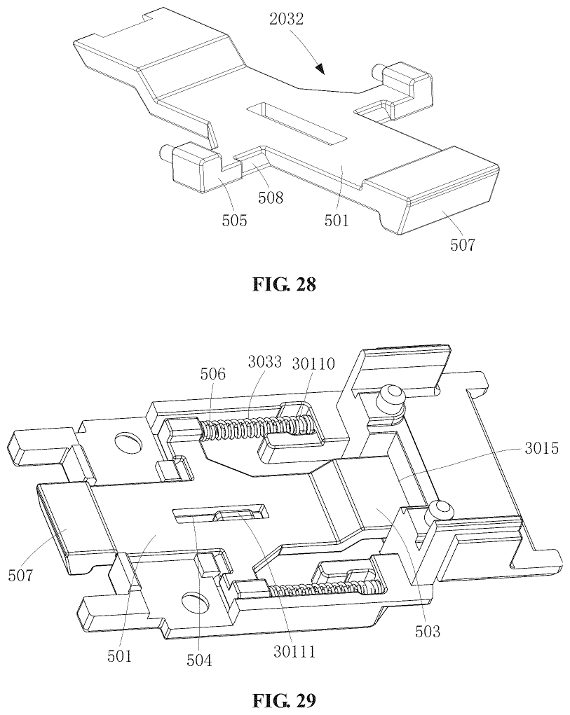

FIG. 26 is a first structural schematic diagram of an unlocker in an electrical module according to some embodiments of the present disclosure, FIG. 27 is a second structural schematic diagram of an unlocker in an electrical module according to some embodiments of the present disclosure, and FIG. 28 is a third structural schematic diagram of an unlocker in an electrical module according to some embodiments of the present disclosure. As shown in FIG. 26, FIG. 27 and FIG. 28, the unlocker 3032 comprises a first plane 501 and a second plane 503, a connecting surface 502 is arranged between the first plane 501 and the second plane 503, and the first plane 501 is fixedly connected to the second plane 503 through a connecting surface 502.

In some embodiments, because the positioning protrusion 3017 is arranged on the top surface of the second supporting plate 3011, and one end of the second plane 503 needs to be moved to the positioning protrusion 3017 to jack up the spring lock hole of the shielding cage 400 engaged with the positioning protrusion 3017, the bottom surface of the second plane 503 should be positioned on the top surface of the second supporting plate 3011. In addition, because the bottom surface of the first supporting plate 3010 protrudes from the top surface of the second supporting plate 3011, and the top surface of the first plane 501 is in contact with the bottom surface of the first supporting plate 3010, as such, the first plane 501 protrudes from the second plane 503, that is, the connecting surface 502 is inclined along the direction of the first plane 501 toward the second plane 503, and the distance between the top surface of the connecting surface 502 and the bottom surface of the first supporting plate 3010 gradually increases.

The first wedge block 509 and the second wedge block 5010 are arranged at one end of the second plane 503 away from the first plane 501, the first wedge block 509 and the second wedge block 5010 extend to the right from the right side of the second plane 503 to the right. Along the left-to-right direction, the height dimensions of the first wedge block 509 and the second wedge block 5010 in the up-down direction gradually decrease, and there is a gap between the first wedge block 509 and the second wedge block 5010, and the gap is arranged opposite to the positioning protrusion 3017.

In some embodiments, the distance between the first wedge block 509 and the second wedge block 5010 is greater than the locking surface of the positioning protrusion 3017, that is, greater than the maximum width of the positioning protrusion 3017, so that when the unlocker 3032 moves to the right to the positioning protrusion 3017, the first wedge block 509 and the second wedge block 5010 can extend out to the right over the positioning protrusion 3017, and the inclined surfaces of the upper side of the first wedge block 509 and the second wedge block 5010 are utilized to displace the spring lock hole on the shielding cage 400 from the positioning protrusion 3017, so that the shielding cage 400 is disengaged from the positioning protrusion 3017, thereby the unlocking is completed when the unlocker 3032 slides to the right.

A boss 505 is arranged on two opposite sides of the first plane 501. The boss 505 protrudes outward from one side of the first plane 501, so that the boss 505 and the first plane 501 are perpendicular to each other, and the top surface of the boss 505 is flush with the first plane 501. The boss 505 is provided with a second mounting column 506. The second mounting column 506 extends from the right side of the boss 505 towards the second plane 503, the second mounting column 506 is parallel to the first plane 501, and the second mounting column 506 is arranged opposite to the first mounting column 30110 on the cover plate 301.

A limiting surface 508 is arranged on the left side of the boss 505 (the side that is turned away from the second plane 503). The limiting surface 508 is inclined opposite to the limiting inclined plate 3014 on the cover plate 301. When the unlocker 3032 is installed on the inner side of the cover plate 301, the unlocker 3032 and the cover plate 301 can be limited by the limiting inclined plate 3014 and the limiting surface 508.

The first plane 501 is provided with a guide groove 504. The guide groove 504 is arranged opposite to the guide column 30111 on the cover plate 301, the guide column 30111 is positioned in the guide groove 504. During the unlocking process of the unlocker 3032, the guide groove 504 can move left and right along the guide column 30111, and the moving direction of the unlocker 3032 is ensured.

A force-bearing portion 507 is arranged at one end of the first plane 501, far away from the second plane 503, and the top surface of the force-bearing portion 507 protrudes beyond the first plane 501. This force-bearing portion 507 comprises a force-bearing surface 5071. Along the direction from bottom to top, the length size of the force-bearing surface 5071 in the left-right direction gradually decreases, that is, the force-bearing surface 5071 is inclined, and the length dimension of the top surface of the force-bearing portion 507 in the left-right direction is smaller than the length dimension of the bottom surface in the left-right direction, facilitating the application of force by the handle 3031 on the force-bearing surface 5071 to drive the unlocker 3032 to move rightward.

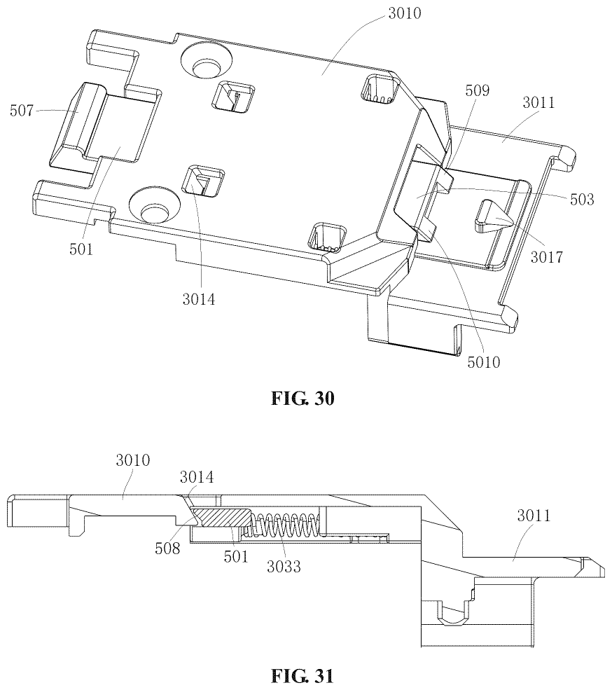

FIG. 29 is a first assembly schematic diagram of a cover plate and an unlocker in an electrical module according to some embodiments of the present disclosure, FIG. 30 is a second assembly schematic diagram of a cover plate and an unlocker in an electrical module according to some embodiments of the present disclosure, and FIG. 31 is an assembly sectional view of a cover plate and an unlocker in an electrical module according to some embodiments of the present disclosure. As shown in FIG. 29, FIG. 30 and FIG. 31, the unlocker 3032 is installed to the inner side of the cover plate 3011 from left to right through the first groove 3012 and the second groove 3013, and the guide column 30111 on the cover plate 301 is inserted into the guide groove 504. Continuing to move rightward, the second plane 503 of the unlocker 3032 passes through the through hole 3015 and is placed on the second supporting plate 3011. Continuing to move rightward, the limiting surface 508 is located on the right side of the limiting inclined plate 3014, and the second mounting column 506 on the unlocker 3032 is arranged opposite to the first mounting column 30110 on the cover plate 301. Then a return spring 3033 is sleeved over the first mounting column 30110 and the second mounting column 506, the unlocker 3032 is not easy to be loosened from the cover plate 3014 under the compression effect of the return spring 3033, the limiting surface 508 is abutted against the limiting inclined plate 3014, and the unlocker 3032 is not easy to be loosened from the cover plate 301 through the inclined recess.

When the limiting surface 508 of the unlocker 3032 is abutted against the limiting inclined plate 3014 of the cover plate 301, the force-bearing portion 507 of the unlocker 3032 is located in the first groove 3012. The unlocker 3032 can be moved to the right by force, so that the force-bearing portion 507 moves to the second groove 3013, and the second plane 503 of the unlocker 3032 moves to the positioning protrusion 3017.

When the unlocker 3032 moves to the left under the action of the return spring 3033, the limiting surface 508 of the unlocker 3032 can move to the left all the way to the limiting inclined plate 3014. The limiting inclined plate 3014 restricts the left-right movement of the unlocker 3032, while the inclined groove interaction between the limiting inclined plate 3014 and the limiting surface 508 ensures the secure connection between the unlocker 3032 and the cover plate 301, effectively preventing the unlocker 3032 from detaching from the cover plate 301.

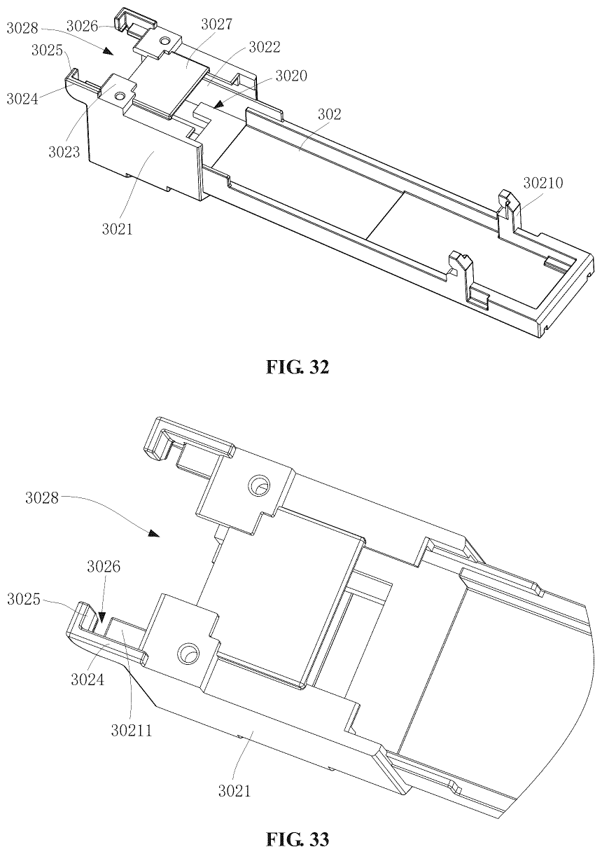

FIG. 32 is a structural schematic diagram of a lower shell part in an electrical module according to some embodiments of the present disclosure. As shown in FIG. 32, one end of the lower shell part 302 comprises a base, which comprises a bottom plate, a first side plate 3021, a second side plate 3022 and a third connecting plate (also referred to as a top plate) 3027. The first side plate 3021 is arranged opposite to the second side plate 3022, one end of the third connecting plate 3027 is connected to the top surface of the first side plate 3021, the other end of the third connecting plate 3027 is connected to the top surface of the second side plate 3022, and the third connecting plate 3027 is arranged opposite to the bottom plate. In this way, a cavity is formed as a fixing cavity 3020 by the bottom plate, the first side plate 3021, the second side plate 3022 and the third connecting plate 3027, and the left and right sides of the fixing cavity 3020 are provided with openings.

In some embodiments, a first connecting plate 3023 is arranged on the top surface of the first side plate 3021. The first connecting plate 3023 extends from the first side plate 3021 to the direction of the second side plate 3022, and the other end of the first connecting plate 3023 is connected to the third connecting plate 3027; a second connecting plate is arranged on the top surface of the second side plate 3022, the second connecting plate extends from the second side plate 3022 to the direction of the first side plate 3021, and the other end of the second connecting plate is connected to the third connecting plate 3027. There is a gap between the first connecting plate 3023 and the second connecting plate, and this gap corresponds to the second groove 3013 on the cover plate 301.

The components between the upper shell part and the lower shell part that are configured to constraining the sliding movement of the unlocker 3032 in the inner side of the cover plate 301 may be generally referred to as an “unlocker movement guiding structure”, which is configured to define the travel limits of the unlocker 3032, wherein an accommodation cavity is formed for the unlocker 3032 to insert. Based on the disclosure of the present application, a person skilled in the art may determine which components of the upper shell part and the lower shell part may be considered to be part of the unlocker movement guiding structure.

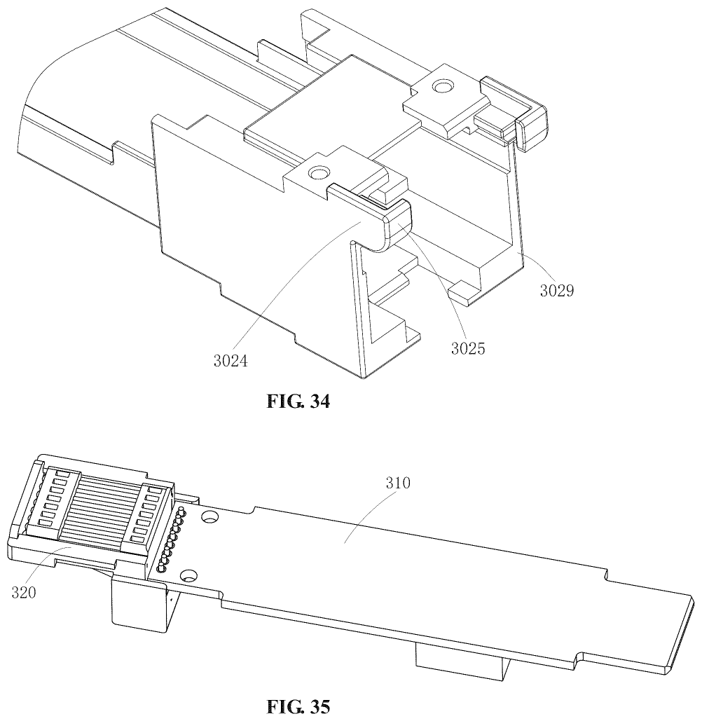

FIG. 33 is a first partial structural schematic diagram of a lower shell part in an electrical module according to some embodiments of the present disclosure, and FIG. 34 is a second partial structural schematic diagram of a lower shell part in an electrical module according to some embodiments of the present disclosure. As shown in FIG. 33 and FIG. 34, a first bracket 3024 is arranged on the first side plate 3021. The first bracket 3024 extends to the left from the left side surface 3029 of the fixing cavity 3020, and a side surface of the first bracket 3024 is flush with the side surface of the first side plate 3021, so that the first bracket 3024 protrudes beyond the first side plate 3021, and the height dimension of the first bracket 3024 in the up-down direction is smaller than the height size of the first side plate 3021 in the up-down direction.

In some embodiments, the left side surface of the first bracket 3024 is arc-shaped. The arc end of the first bracket 3024 is connected to a second bracket 3025, one end of the second bracket 3025 is fixedly connected to one end of the first bracket 3024, and the first bracket 3024 is perpendicular to the second bracket 3025, so that the first bracket 3024 forms a first L-shaped groove with the second bracket 3025.

A first fixing bracket 30211 is arranged in the first L-shaped groove formed by the first bracket 3024 and the second bracket 3025. The top surface of the first bracket 3024 and the top surface of the second bracket 3025 protrude beyond the top surface of the first fixing bracket 30211, the first fixing bracket 30211 extends from the inner side of the first bracket 3024 to the direction of the second side plate 3022, and a side of the first fixing bracket 30211 is fixedly connected to the inner side of the first bracket 3024. The two ends of the first fixing bracket 30211 are respectively connected to the left side surface of the first connecting plate 3023 and the inner side of the second bracket 3025.

The first fixing bracket 30211 is provided thereon with a first positioning hole 3026. The first positioning hole 3026 passes through the top surface and the bottom surface of the first fixing bracket 30211, and the first positioning hole 3026 passes from the inner side of the first bracket 3024 to the outer side surface of the first fixing bracket 30211.

In some embodiments, a third bracket and a fourth bracket are arranged on the second side plate 3022, the third bracket is arranged opposite to the first bracket 3024, the third bracket forms a second L-shaped groove with the fourth bracket, a second fixing bracket is arranged in the second L-shaped groove, the side surface of the second fixing bracket is fixedly connected to the inner side of the third bracket, and the two ends of the second fixing bracket are respectively connected to the left side surface of the second connecting plate and the inner side of the fourth bracket; the second fixing bracket is provided thereon with a second positioning hole, the second positioning hole passes through the second fixing bracket, and the second positioning hole is arranged opposite to the first positioning hole 3026.

In some embodiments, there is a gap between the first bracket 3024 and the third bracket, between the second bracket 3025 and the fourth bracket, between the first fixing bracket 30211 and the second fixing bracket. The gap forms a bracket groove 3028, that is, a bracket groove 3028 is formed between the first L-shaped groove and the second L-shaped groove, and the top surface, bottom surface and left side of the bracket groove 3028 are all provided with openings.

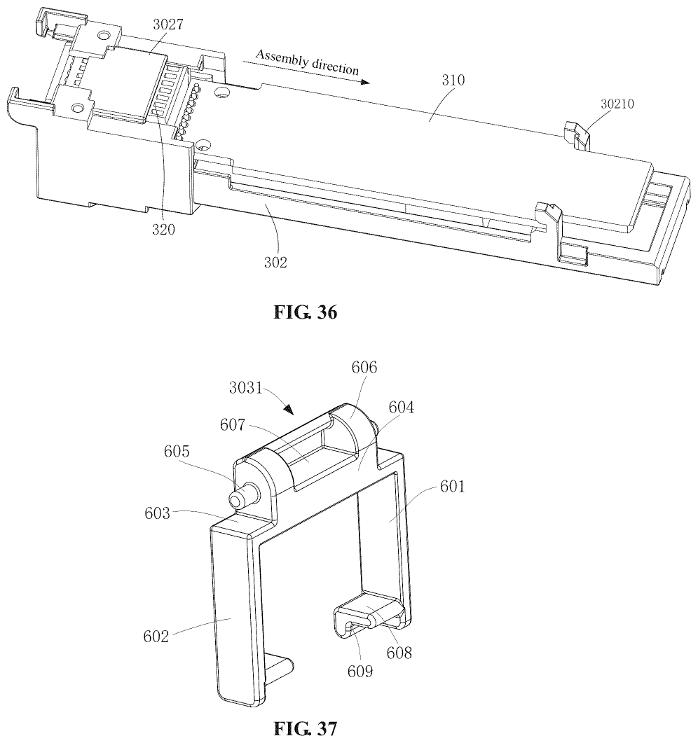

FIG. 35 is an assembly schematic diagram of a circuit board and an electrical connector in an electrical module according to some embodiments of the present disclosure, and FIG. 36 is an assembly schematic diagram of a lower shell part, a circuit board and an electrical connector in an electrical module according to some embodiments of the present disclosure. As shown in FIG. 35 and FIG. 36, the electrical module 300 provided in the embodiment of the present disclosure further comprises an electrical connector 320. One end of the electrical connector 320 is electrically connected to the circuit board 310 through a pin, and the other end of the electrical connector 320 can be connected to the network cable 103 so as to achieve the electrical connection between the network cable 103 and the electrical module 300. The network cable 103 transmits the electrical signal to the circuit board 310 through the electrical connector 320, transmits to the gold finger on the circuit board 310 through the signal line on the electrical module 300, transmits to the local information processing device 2000 through the gold finger, thereby realizing the electrical signal transmission between the host computer 100 and the local information processing device 2000.

In some embodiments, the electrical connector 320 is an RJ45 (Registered Jack 45) electrical connector, and the RJ45 electrical connector is a kind of information socket (i.e., communication lead-out terminal) connector in a wiring system. The RJ45 connector is composed of a plug and a socket, and the connector composed of these two components is connected between the wires to achieve the electrical continuity of wires.

First, the electrical connector 320 is connected to the circuit board 310 to form an electrical assembly, and then the electrical component is installed into the lower shell part 302. Because the size of the RJ45 electrical connector is larger, the electrical component can not be assembled in a conventional assembly mode from top to bottom, but assembled by inserting from the head, that is, the electrical assembly is assembled into the lower shell part 302 from left to right through the fixing cavity 3020 of the lower shell part 302.

After assembling the electrical assembly to the lower shell part 302 according to the assembly direction (shown in FIG. 36), the left side surface of the electrical connector 320 is flush with the left side surface 3029 of the fixing cavity 3020, and the inner side of the third connecting plate 3027 can be in contact with the top surface of the electrical connector 320, so that the electrical connector 320 is limited in the up-down direction through the third connecting plate 3027.

In some embodiments, a support card holder 30210 is arranged on the bottom plate of the lower shell part 302, and the support card holder 30210 is used for supporting and fixing the circuit board 310 so as to facilitate the assembly and fixation of the circuit board 310. The support card holder 30210 can be provided with a support card slot, and the opening of the support card slot is oriented towards the fixing cavity 3020. The support card slot is arranged opposite to the notch on the circuit board 310. When the circuit board 310 is assembled to the lower shell part 302, the notch on the circuit board 310 corresponds to the support card slot on the support card holder 30210 and is configured for the limiting fixation of the circuit board 310, so as to facilitate the fixation of the circuit board 310 in the lower shell part 302.

During the electrical component assembly process, the electrical component is inserted from the fixing cavity 3020 of the lower shell part 302 until the notch on the circuit board 310 is matched with the support card slot, so that the circuit board 310, the electrical connector 320 and the lower shell part 302 are conveniently assembled, and the assembly efficiency of the electrical module 300 is improved.

In some embodiments, after the electrical module 300 assembles the circuit board 310 and the electrical connector 320 into an electrical assembly, the electrical assembly is inserted into the lower shell part 302 from one end of the lower shell part 302 (the left end opening of the fixing cavity 3020), and then the cover plate 301 and the unlocking mechanism 303 are assembled to the lower shell part 302 to complete the assembly of the electrical module 300. In the optical module, because the circuit board of optical modules is provided with optoelectronic components such as an optical transmitter assembly and an optical receiver assembly, the unlocking mechanism is first assembled on the lower shell part, then the circuit board is installed in the lower shell part from top to bottom, and then the optoelectronic components such as an optical transmitter assembly and an optical receiver assembly are installed on the circuit board, and then the upper shell part is covered on the lower shell part to complete the assembly of the optical module.

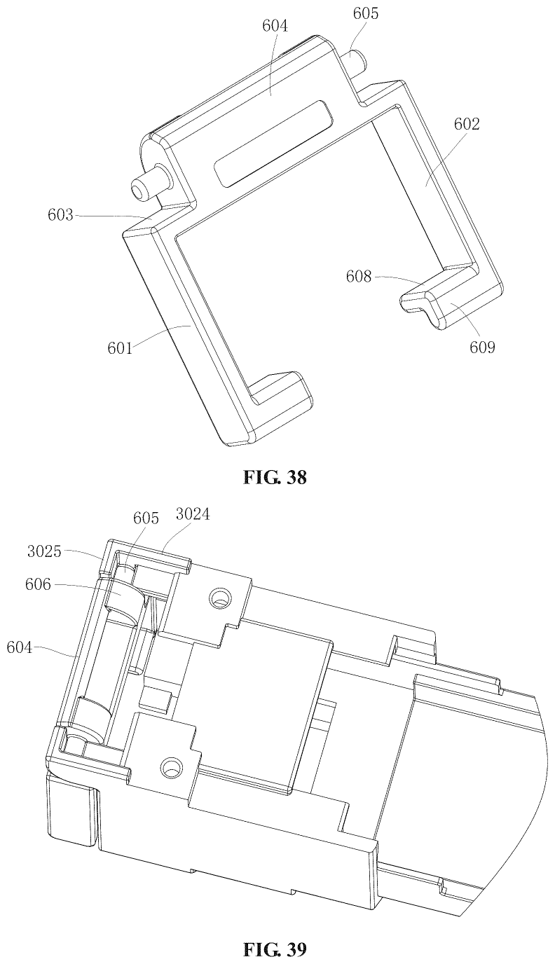

FIG. 37 is a first structural schematic diagram of a handle in an electrical module according to some embodiments of the present disclosure, and FIG. 38 is a second structural schematic diagram of a handle in an electrical module according to some embodiments of the present disclosure. As shown in FIG. 37 and FIG. 38, the handle 3031 of the unlocking mechanism 303 comprises a first cantilever 601, a second cantilever 602 and a crossbeam 603. The first cantilever 601 is arranged opposite to the second cantilever 602, one end of the crossbeam 603 is fixedly connected to one end of the first cantilever 601, and the other end of the crossbeam 603 is fixedly connected to one end of the second cantilever 602, so that the first cantilever 601, the second cantilever 602 are connected to the crossbeam 603 to form a U-shaped frame.

The crossbeam 603 is provided with a force-applying boss 604. The force-applying boss 604 extends outward from the top surface of the crossbeam 603, so that the force-applying boss 604 is turned away to the first cantilever 601 and the second cantilever 602. The thickness size of the force-applying boss 604 in the left-right direction can be the same as the thickness size of the crossbeam 603 in the left-right direction, the length size of the force-applying boss 604 in the front-rear direction is smaller than the length size of the crossbeam 603 in the front-rear direction, and the distance between the front side surface of the force-applying boss 604 and the first cantilever 601 and the distance between the rear side surface of the force-applying boss 604 and the second cantilever 602 are the same, so that the central axis of the force-applying boss 604 coincides with the central axis of the crossbeam 603.

The front and rear side surfaces of the force-applying boss 604 are all provided with a positioning pins 605. One positioning pin extends towards the first cantilever 601 from the front side surface of the force-applying boss 604, another positioning pin 605 extends towards the second cantilever 602 from the rear side surface of the force-applying boss 604. The positioning pin 605 is arranged aligned with the first positioning hole 3026 on the lower shell part 302, and the positioning pin 605 can be inserted into the first positioning hole 3026.

In some embodiments, the left side surface of the force-applying boss 604 is a plane, and the right side surface is an arc surface. The arc surface is an unlocking surface 606. The force-bearing portion 507 of the unlocker 3032 is located at the right side of the unlocking surface 606, and the unlocking surface 606 is in close contact with the force-bearing portion 507, such that the unlocker 3032 is driven to slide to the right when the handle 3031 rotates, and the reset of the handle 3031 is completed by sliding to the left of the unlocker 3032 with the elastic force of the return spring 3033.

In some embodiments, a mounting groove 607 is arranged on the unlocking surface 606 of the force-applying boss 604. The mounting groove 607 extends from the unlocking surface 606 to the left side of the force-applying boss 604, an opening is arranged on the right side of the mounting groove 607, the mounting groove 607 corresponds to the force-bearing portion 507 of the unlocker 3032, and when the electrical module 300 is in a locked state, the force-bearing portion 507 can be located in the mounting groove 607 to save the overall size of the electrical module 300.

The lower end of the first cantilever 601 (one end away from the crossbeam 603) is provided with a first hand-held arm 608 and a second hand-held arm 609. The first hand-held arm 608 is arranged along the left-right direction, is fixedly connected to the inner side of the first cantilever 601, and is perpendicular to the first cantilever 601; One end of the second hand-held arm 609 is fixedly connected to the left end face of the first hand-held arm 608, the second hand-held arm 609 is parallel to the first cantilever 601, so that the first hand-held arm 608 forms an L-shaped hand-held portion with the second hand-held arm 609. And the L-shaped hand-held portion is used for providing the rotating force of the handle 3031 to facilitate the user to grab the L-shaped hand-held portion and rotate the handle 3031.

The lower end of the second cantilever 602 is also provided with a third hand-held arm and a fourth hand-held arm, the third hand-held arm is arranged along the left-right direction, is fixedly connected to the inner side of the second cantilever 602, and is perpendicular to the second cantilever 602; One end of the fourth hand-held arm is fixedly connected to the left end face of the third hand-held arm, and the fourth hand-held arm is parallel to the second cantilever 602, so that the third hand-held arm and the fourth hand-held arm form an L-shaped hand-held portion, so that the user is convenient to grab the L-shaped hand-held portion and rotate the handle 3031.

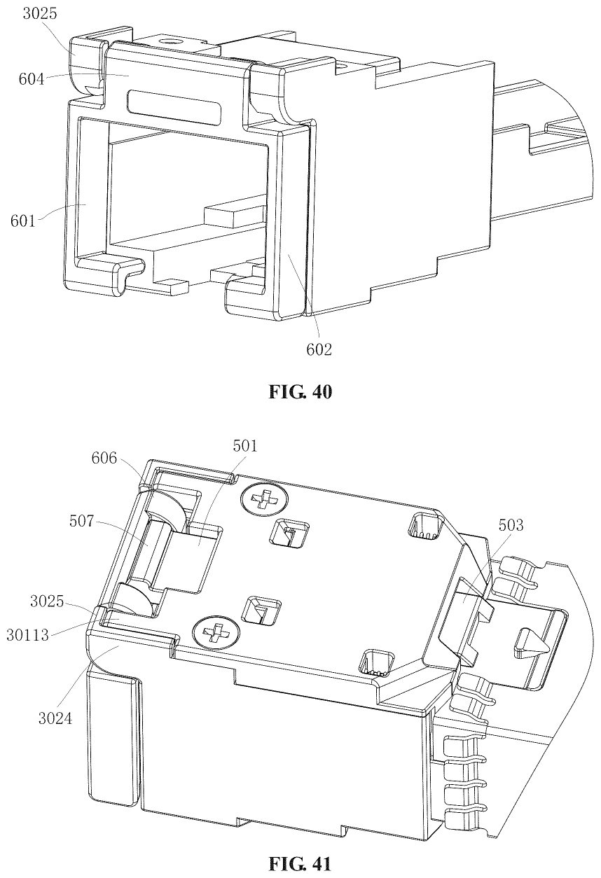

FIG. 39 is a first partial assembly schematic diagram of a handle and a lower shell part in an electrical module according to some embodiments of the present disclosure, and FIG. 40 is a second partial assembly schematic diagram of a handle and a lower shell part in an electrical module according to some embodiments of the present disclosure. As shown in FIG. 39 and FIG. 40, after the circuit board 310 and the electrical connector 320 are assembled together to the lower shell part 302, the handle 3031 is assembled into the bracket groove 3028 of the lower shell part 302, the two positioning pins 605 of the handle 3031 are respectively inserted into the first positioning hole 3026 and the second positioning hole of the lower shell part 302, the unlocking surface 606 of the handle 3031 is oriented towards the fixing cavity 3020, and the crossbeam 603 is located below the arc end of the first bracket 3024, so that when the user grabs the L-shaped hand-held portion of the handle 3031, under the action of external force, the positioning pin 605 of the handle 3031 can rotate in the first positioning hole 3026 and the second positioning hole, and the handle 3031 can rotate clockwise and counterclockwise in the bracket groove 3028.

In some embodiments, after the positioning pin 605 of the handle 3031 is inserted into the first positioning hole 3026 and the second positioning hole of the lower shell part 302, and when the left side surface of the handle 3031 is parallel to the left side surface 3029 of the fixing cavity 3020, the left side surface of the force-applying boss 604 can be flush with the left side surface of the second bracket 3025.

In some embodiments, after the handle 3031 is assembled to the bracket groove 3028 of the lower shell part 302, the force-applying boss 604 of the handle 3031 is located above the fixing cavity 3020, the first cantilever 601, the second cantilever 602 and the L-shaped hand-held portion are located below the force-applying boss 604, and after the user grabs the L-shaped hand-held portion, the handle 3031 is rotated from bottom to top.

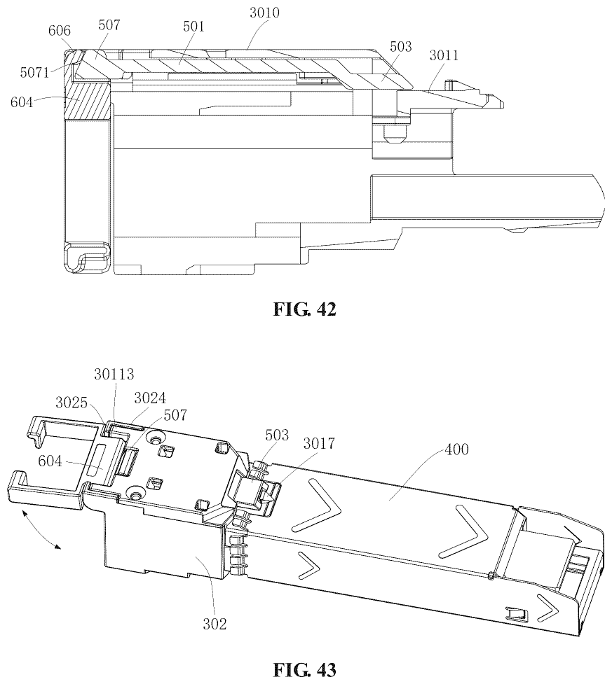

FIG. 41 is a partial assembly schematic diagram of a handle, a lower shell part, a cover plate and an unlocker in an electrical module according to some embodiments of the present disclosure, and FIG. 42 is a partial assembly sectional view of a handle, a lower shell part, a cover plate and an unlocker in an electrical module according to some embodiments of the present disclosure. As shown in FIG. 41 and FIG. 42, after the handle 3031 is assembled to the bracket groove 3028 of the lower shell part 302, the assembled cover plate 301 and the unlocker 3032 are assembled to the lower shell part 302 to complete the assembly of the electrical module 300.

Specifically, the threaded holes on the first supporting plate 3010 in the cover plate 301 are aligned with the threaded holes on the first connecting plate 3023 and the second connecting plate on the lower shell part 302, the positioning column 30112 on the second supporting plate 3011 is inserted into the positioning holes on the circuit board 310, and the side wall 30113 on the first supporting plate 3010 is inserted into the L-shaped groove formed by the first bracket 3024 and the second bracket 3025 on the lower shell part 302, the force-bearing portion 507 of the unlocker 3032 is placed in the mounting groove 607 of the handle 3031, the unlocking surface 606 of the handle 3031 is in close contact with the force-bearing surface 5071 of the force-bearing portion 507, and finally the cover plate 301 is fixedly connected to the lower shell part 302 through locking screws.

When the handle 3031 is in a vertical state, and the force-bearing portion 507 of the unlocker 3032 is located in the mounting groove 607 of the handle 3031, the electrical module 300 is in a locked state, the return spring 3033 is in a compression state, the force-bearing surface 5071 of the unlocker 3032 presses against the unlocking surface 606 of the handle 3031, so that the unlocker 3032 and the handle 3031 are not loosened, and the distance between the second plane 503 extended out by the unlocker 3032 and the positioning protrusion 3017 meets protocol specifications.

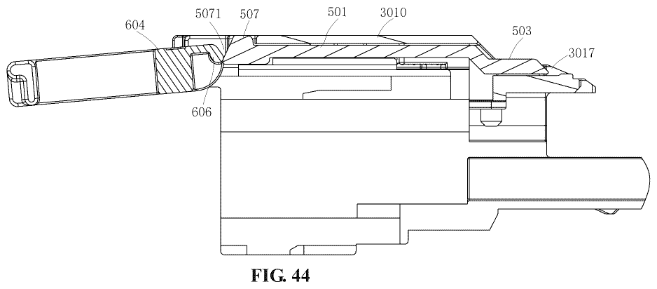

FIG. 43 is a schematic diagram of an unlocked state of an electrical module according to some embodiments of the present disclosure, and FIG. 44 is a sectional view of an unlocked state of an electrical module according to some embodiments of the present disclosure. As shown in FIG. 43 and FIG. 44, when the user wants to unlock the electrical module 300, he/she can grasp the L-shaped hand-held portion of the handle 3031, and rotates the handle 3031 from bottom to top, and then the unlocking surface 606 of the handle 3031 presses against the force-bearing surface 5071 of the unlocker 3032, driving the unlocker 3032 to move to the right. When the handle 3031 is in a horizontal state, the force-bearing portion 507 of the unlocker 3032 moves to the second groove 3013, the connecting surface 502 of the unlocker 3032 moves to the right to the through hole 3015, the second plane 503 of the unlocker 3032 moves to the right to the positioning protrusion 3017, the first wedge block 509 and the second wedge block 5010 at the end of the second plane 503 displace the spring lock hole on the shielding cage 400, so that the shielding cage 400 is separated from the positioning protrusion 3017, thus the unlocking of the electrical module 300 is achieved. When the electrical module 300 is in the unlocked state, the handle 3031 is pulled outward at this moment, and the electrical module can be pulled out of the shielding cage 400 smoothly.

When the user releases the L-shaped hand-held portion of the handle 3031, because the return spring 3033 is in a stretched state, the unlocker 3032 moves to the left under the reset force of the return spring 3033, and the unlocker 3032 drives the handle 3031 to rotate from top to bottom, so that the handle 3031 realizes automatic reset.

In some embodiments, because the top surface of the force-bearing portion 507 of the unlocker 3032 protrudes from the first plane 501, when the unlocker 3032 moves to the right to the second groove 3013, the connecting wall of the second groove 3013 limits the force-bearing portion 507, prevents the unlocker 3032 from continuing to move to the right, and limits the moving range of the unlocker 3032.

In some embodiments, the cover plate 301 is assembled on the lower shell part 302 through screws, which makes installation and disassembly more convenient, and is conducive to the rework of the electric module 300. And the disassembled cover plate 301 can also be reused, which also saves costs.

When assembling the electrical module 300 provided in the embodiment of the present disclosure, the unlocker 3032 is first assembled into the cover plate 301, and the unlocker 3032 can move left and right in the cover plate 301; then the return spring 3033 is fixed between the unlocker 3032 and the cover plate 301 through a mounting column, and is tightly matched under the action of the return spring 3033, so that the unlocker 3032 is not easy to be loosened from the cover plate 301; then the electrical assembly composed of the circuit board 310 and the electrical connector 320 is inserted into the lower shell part 302 through the fixing cavity 3020 of the lower shell part 302 to fix the circuit board 310 and the electrical connector 320 in the lower shell part 302; then the handle 3031 is inserted into the bracket groove 3028 of the lower shell part 302, so that the handle 3031 can rotate around the bracket groove 3028 under the action of external force. Finally, the cover plate 301 and the unlocker 3032 are assembled together on the lower shell part 302, so that the handle 3031 is in close contact with the unlocker 3032, and when the handle 3031 is rotated, the unlocker 3032 can be driven to move to the right.

When the handle 3031 is in a vertical state, the electrical module 300 is in a locked state, and when unlocking is required, the handle 3031 is lifted and rotated upward, the unlocker 3032 moves to the right along the guide column 30111 of the cover plate 301 under the action of the unlocking surface 606 and the force-bearing surface 5071 in close contact, and the spring sheet of the shielding cage 400 is jacked and opened through the wedge inclined surface of the unlocker 3032. During this process, the return spring 3033 is in a compressed state. The unlocker 3032 receives an increase in the clastic force of the return spring 3033 to the left.

When the handle 3031 is rotated to the horizontal position, the unlocker 3032 moves to the right to the extreme position, and the two wedge blocks of the unlocker 3032 exceed the positioning protrusion 3017 and stretch out to the right, and the spring sheet on the shielding cage 400 is pushed and opened by utilizing the inclined plane on the upper side of the wedge block, so that the spring lock hole on the shielding cage 400 is disengaged from the positioning protrusion 3017 so as to complete the unlocking.

After the unlocking is completed, the handle 3031 is released, the external force acting on the handle 3031 disappears, and the unlocker 3032 moves to the left under the action of the return spring 3033, so that the handle 3031 that is in close contact with the unlocker 3032 returns to its original position under the thrust of the force-bearing portion 507, thereby completing the unlocking process.

In the present disclosure, the positioning protrusion on the cover plate is matched with the spring-lock hole on the shield cage 400 to lock the position, so that the electric module can be firmly locked in the shielding cage 400, and the unlocking mechanism is used to release the lock position simultaneously, and only a set of action parts can be unlocked, so that the unlocking movement and the reset of the unlocking mechanism after unlocking are smoother and safer and stable. The assembly mode of this unlocking mechanism is simple, and the return spring is not easy to loosen. It is easy to disassemble, can achieve automatic return, and is reliable to use.

Finally, it should be noted that the above embodiments are only used to illustrate the technical solutions of the present disclosure, rather than to limit them; Although the present disclosure has been described in detail with reference to the foregoing embodiments, those skilled in the art should understand that they may still modify the technical solutions described in the foregoing embodiments, or replace some of the technical features therein. These modifications or replacements do not deviate the essence of the corresponding technical solutions from the spirit and scope of the technical solutions of the embodiments of the present disclosure.

What is claimed is:

1. An optical module, comprising:
a shell having an unlocker movement guiding structure that is configured to limit movement position of an unlocker, a positioning protrusion arranged on an outer wall of the shell, and a first pivotable positioning member arranged on a side of the shell, wherein the positioning protrusion and the unlocker movement guiding structure are arranged on a same side of the shell; and
an unlocking mechanism that is connected to the shell and comprises a handle and the unlocker, the handle being disposed thereon with a second pivotable positioning member and an unlocking surface, wherein
the handle is pivotally connected to the shell through engagement and connection between the second pivotable positioning member and the first pivotable positioning member;
a return spring is arranged in an accommodation cavity of the unlocker movement guiding structure, and the return spring connects the unlocker and the shell;
one side of the unlocker is inserted into the accommodation cavity of the unlocker movement guiding structure, and an end of another side of the unlocker opposite to the one side contacts the unlocking surface, such that a force applied when the handle is rotated drives the unlocker to slide on the shell, wherein, the applied force drives the unlocker to slide and compress the return spring until locking on the positioning protrusion by an external device is unlocked during an unlocking process; and after the unlocking process, as the applied force is removed, the compressed return spring drives the unlocker to slide on the shell, and sliding of the unlocker drives the handle to rotate back to its original position.

2. The optical module according to claim 1, wherein the unlocker comprises a main plate, and a first plug-in plate and a second plug-in plate that are respectively arranged on opposite sides of the main plate, and wherein the first plug-in plate and the second plug-in plate are inserted into the accommodation cavity; and the return spring is arranged between the first plug-in plate and an inner wall of the accommodation cavity and between the second plug-in plate and the inner wall of the accommodation cavity.

3. The optical module according to claim 2, wherein one end of each of the first plug-in plate and the second plug-in plate that is inserted into the accommodation cavity is disposed with a mounting post, and the return spring is sleeved on the mounting post.

4. The optical module according to claim 2, wherein a side surface of the first plug-in plate is disposed with a first contact surface, a side surface of the second plug-in plate is disposed with a third contact surface, and the return spring is arranged between the inner wall of the accommodation cavity and the first contact surface and the third contact surface.

5. The optical module according to claim 1, wherein a bottom surface of the unlocker is disposed with a protrusion plate; and a bottom of the accommodation cavity is formed thereon with a mounting groove, and a limiting surface is disposed in the mounting groove, and wherein the protrusion plate is located in the mounting groove, and the limiting surface is configured to abut against the protrusion plate so as to limit the unlocker.

6. The optical module according to claim 5, wherein:
the shell is disposed thereon with a first guide column and a second guide column; a first supporting plate and a second supporting plate are disposed on opposite sides of the unlocker; and the protrusion plate comprises a first protrusion plate and a second protrusion plate arranged on a bottom surface of the unlocker; and
the first protrusion plate and the second protrusion plate are located between the first supporting plate and the second supporting plate; a first guide groove is formed between the first supporting plate and the first protrusion plate, the first guide groove being matched with the first guide column; and a second guide groove is formed between the second supporting plate and the second protrusion plate, the second guide groove being matched with the second guide column.

7. The optical module according to claim 6, wherein:
a third guide groove is formed between the first protrusion plate and the second protrusion plate, the third guide groove being matched with a portion of the shell between the first guide groove and the second guide groove;
the mounting groove comprises a first mounting groove and a second mounting groove that are arranged on the shell and are located between the first guide column and the second guide column, and there is a gap between the first mounting groove and the second mounting groove;
the first protrusion plate is located in the first mounting groove, and the second protrusion plate is located in the second mounting groove; the limiting surface comprises a first limiting surface disposed in the first mounting groove and a second limiting surface disposed in the second mounting groove; the first limiting surface is configured to abut against the first protrusion plate, and the second limiting surface is configured to abut against the second protrusion plate so as to limit the unlocker; and
the first mounting groove is communicated with the first accommodation cavity, and the second mounting groove is communicated with the second accommodation cavity.

8. The optical module according to claim 6, wherein:
the handle comprises a crossbeam, and a first cantilever and a second cantilever arranged at opposite ends of the crossbeam; the first cantilever is disposed thereon with a first connecting beam and a first anti-detachment hook, wherein one end of the first connecting beam is fixedly connected with the first cantilever, and the other end of the first connecting beam is fixedly connected with the first anti-detachment hook; the first guide column and the first protrusion plate are located between the first anti-detachment hook and the first cantilever; and
the second cantilever is disposed thereon with a second connecting beam and a second anti-detachment hook, wherein one end of the second connecting beam is fixedly connected with the second cantilever, and the other end of the second connecting beam is fixedly connected with the second anti-detachment hook; the second guide column and the second protrusion plate are located between the second anti-detachment hook and the second cantilever; and
there is a gap between the first protrusion plate and the first anti-detachment hook, and there is a gap between the second protrusion plate and the second anti-detachment hook.

9. The optical module according to claim 1, wherein:
the shell comprises a lower shell part, and the lower shell part comprises a base, the base comprising a bottom plate, a first side plate and a second side plate that are arranged opposite to each other and are respectively connected to opposite sides of the bottom plate;
the bottom plate is formed thereon with a U-shaped groove, and the return spring is placed in the U-shaped groove;
the positioning protrusion and the unlocker movement guiding structure are arranged on the bottom plate, and
the first pivotable positioning member comprises a first positioning column arranged on the first side plate and a second positioning column arranged on the second side plate.

10. The optical module according to claim 9, wherein:
the handle comprises a crossbeam, and a first cantilever and a second cantilever that are arranged at opposite ends of the crossbeam;
the second pivotable positioning member comprises a first positioning hole arranged in the first cantilever and a second positioning hole arranged in the second cantilever, the first positioning column being inserted into the first positioning hole, and the second positioning column being inserted into the second positioning hole; the unlocking surface comprises a first unlocking surface arranged on one end of the first cantilever away from the crossbeam and a second unlocking surface arranged on one end of the second cantilever away from the crossbeam; and
the first unlocking surface and the first unlocking surface are arc surfaces.

11. The optical module according to claim 9, wherein the lower shell part comprises a limiting plate that is located below the bottom plate, and the accommodation cavity is formed between the limiting plate and the bottom plate.

12. The optical module according to claim 10, wherein:
a first boss is arranged on the first side plate, and the first boss is disposed thereon with a third limiting surface, the third limiting surface being arranged corresponding to the first cantilever so as to limit rotation of the handle through the third limiting surface when the optical module is in an unlocked state; and
a second boss is arranged on the second side plate, and the second boss is disposed thereon with a fourth limiting surface, the fourth limiting surface being arranged corresponding to the second cantilever so as to limit rotation of the handle through the fourth limiting surface when the optical module is in the unlocked state.

13. The optical module according to claim 12, wherein the limiting plate comprises a first limiting plate and a second limiting plate, and wherein:
one side of the first limiting plate is connected with the first boss, and there is a gap between the first limiting plate and the bottom plate in an up-down direction; one side of the second limiting plate is connected with the second boss, and there is a gap between the second limiting plate and the bottom plate in the up-down direction; and
the accommodation cavity comprises a first accommodation cavity and a second accommodation cavity, the first accommodation cavity being formed by the first limiting plate, the bottom plate and the first boss, and the second accommodation cavity being form by the second limiting plate, the bottom plate and the second boss.

14. The optical module according to claim 2, wherein:
the accommodation cavity comprises a first accommodation cavity and a second accommodation cavity, with a gap formed between the first accommodation cavity and the second accommodation cavity; the first plug-in plate is inserted into the first accommodation cavity, and the second plug-in plate is inserted into the second accommodation cavity;
the main plate comprises a first main plate and a second main plate fixedly connected with the first main plate, and wherein in a direction perpendicular to a plug-in direction of the optical module, a width of the first main plate is larger than a width of the second main plate;
the first plug-in plate and the second plug-in plate are respectively arranged at opposite sides of the second main plate, and the second main plate is inserted into the gap between the first accommodation cavity and the second accommodation cavity; a third limiting plate is disposed in the first accommodation cavity, a fourth limiting plate is disposed in the second accommodation cavity, and the return spring is arranged between the third limiting plate and the first contact surface and between the fourth limiting plate and the third contact surface.

15. The optical module according to claim 1, wherein:
an unlocking end of the unlocker that is away from the handle is connected with a connecting plate, the connecting plate is further connected with a first connecting arm and a second connecting arm, with a gap formed between the first connecting arm and the second connecting arm; and
the first connecting arm is further connected with a first wedge block, the second connecting arm is further connected with a second wedge block, and a distance between the first wedge block and the second wedge block is larger than a gap between the first connecting arm and the second connecting arm, such that the positioning protrusion can be located between the first wedge block and the second wedge block during the unlocking process.

16. The optical module according to claim 9, wherein:
a bottom surface of the unlocker is disposed thereon with a guide groove; the shell is disposed thereon with a guide column; and the guide groove is matched with the guide column when the unlocker is installed on the lower shell part such that the unlocker is moved along the guide column.

17. The optical module according to claim 1, wherein:
the shell comprises an upper shell part and a lower shell part, and the upper shell part is covered on the lower shell part to enclose a cavity for accommodating a circuit board with the lower shell part;
one end of the lower shell part is arranged with a fixing cavity, and an electrical connector electrically connected to the circuit board is inserted into the fixing cavity;
the upper shell part comprises a cover plate that is covered on the fixing cavity; and
the positioning protrusion is arranged on the cover plate;
the accommodating cavity of the unlocker movement guiding structure is defined by a portion of the cover plate and a portion of the lower shell part;
the return spring connects the unlocker and the cover plate in the accommodation cavity of the unlocker movement guiding structure;
during the unlocking process, the handle is rotated to drive the unlocker to slide and compress the return spring in the accommodation cavity of the unlocker movement guiding structure until the locking on the positioning protrusion is unlocked; and
after the unlocking process, the compressed return spring drives the unlocker to slide in the cover plate.

18. The optical module according to claim 17, wherein:
the cover plate comprises a first supporting plate, a second supporting plate and a cover connecting plate,
the first supporting plate is connected to the second supporting plate through the cover connecting plate;
a top surface of the first supporting plate is protruded relative to a top surface of the second supporting plate such that the accommodation cavity is formed between the first supporting plate and the lower shell part;
the positioning protrusion is arranged on the top surface of the second supporting plate;
and the cover connecting plate is disposed thereon with a through hole, through which an inner side of the first supporting plate is communicated with the top surface of the second supporting plate;
one end of the first supporting plate is formed with a first groove and a second groove that is located between the first groove and the through hole, and the second groove is communicated with the first groove; and
the unlocker is inserted into the through hole via the first groove, the second groove and the accommodation cavity; and the unlocker is slidable in the first groove and the second groove.

19. The optical module according to claim 18, wherein:
the first supporting plate is disposed, on opposite sides thereof, with side plates, and is disposed on an inner side thereof with symmetrically arranged fixing blocks,
one end of each fixing block is fixedly connected to one side plate of the first supporting plate, and a limiting plate is disposed at the other end of the fixing block, with a gap formed between the limiting plate and the side plate;
a spring groove is formed by each side plate, one corresponding fixing block and one corresponding limiting plate;
a first mounting column is disposed in each spring groove;
the unlocker comprises a first plane, wherein one end of the first plane is disposed with a force-bearing portion, and the force-bearing portion is located in the first groove and the second groove;
bosses are disposed on opposite sides of the first plane, and a second mounting column is disposed on a side surface of each boss facing away from the force-bearing portion, each second mounting column being arranged corresponding to one first mounting column; and
the return spring is sleeved on the first mounting column and the second mounting column.

20. The optical module according to claim 19, wherein:
the inner side of the first supporting plate is disposed with symmetrically arranged limiting recesses, and wherein each limiting recess comprises a limiting hole and a limiting inclined plate, the limiting inclined plate being arranged inclined, one end of the limiting inclined plate being fixedly connected to an edge of the limiting hole, and an inclined surface of the limiting inclined plate facing the through hole;
a side of the boss facing the force-bearing portion is disposed with an inclined arranged limiting surface, and the limiting surface is corresponded to and engaged with the limiting inclined plate;
a top surface of the force-bearing portion is protruded relative to the first plane, and when the optical module is in an unlocked state, the force-bearing portion abuts against a connecting wall of the second groove.
